(19) United States
(12) Patent Application Publication
(10) Pub. No.: US 2003/0119193 A1
(43) Pub. Date: Jun. 26, 2003

(54) System and method for high throughput screening of droplets

(76) Inventors: Robert Hess, Arlington, MA (US); Colin Brenan, Marblehead, MA (US); John Linton, Lincoln, MA (US); Can Ozbal, Cambridge, MA (US); Donald Green, Watertown, MA (US); Ian Hunter, Lincoln, MA (US)

Correspondence Address: BROMBERG & SUNSTEIN LLP, 125 SUMMER STREET, BOSTON, MA, 02110-1618, US

(21) Appl. No.: 10/267,912

(22) Filed: Oct. 8, 2002

Related U.S. Application Data
(63) Continuation-in-part of application No. 09/842,361, filed on Apr. 25, 2001.

(51) Int. Cl. G01N 35/00

(52) U.S. Cl. 436/44; 422/66

(57) ABSTRACT

A system and method for high throughput screening of fluid samples. A reduced pressure is applied, via an injection valve, to a sample aspiration tube. A first fluid and a second fluid are alternatively aspirated, via the sample aspiration tube, the first fluid for filling a sample loop with samples, the second fluid for flushing the sample aspiration tube. Excess fluid aspirated from the first fluid source and all fluid aspirated from the second fluid source is captured in an inline trap.

### CROSS REFERENCE TO RELATED APPLICATIONS

This application is a continuation-in-part of U.S. patent application Ser. No. 09/842361, filed Apr. 25, 2001, entitled “System and Method for High Throughput Processing of Droplets,” which is hereby incorporated by reference, in its entirety.

### TECHNICAL FIELD AND BACKGROUND ART

The present invention relates generally to high throughput screening of fluidic samples, and more particularly, to the transporting and analyzing a massive number of droplets, where the analyzing may include, for example, mass spectrometry.

Recent advances in genomics and proteomics have delivered a large number of potential targets for novel therapeutics. A common first step in the process of discovering new pharmaceutical compounds is to perform a large number of biochemical assays, so as to apply a large numbers of chemical compounds, commonly referred to as chemical libraries, against these targets. This process of assaying chemical libraries with potential biological targets is known as High Throughput Screening (HTS). In HTS, it is desirable to assess the interaction (eg: binding, inhibition, activation, etc) between a target and each member of a chemical library as quickly and efficiently as possible. A large number of samples, potentially on the order of hundreds of thousand or millions per day, in the form of droplets having sizes on the order of, for example, two hundred microliters or smaller, may be dispensed, moved, combined with reagents, and/or analyzed during HTS.

There are numerous problems associated with current technologies dealing with HTS. For example, when dispensing droplets onto a surface via a solenoid valve or similar device, the amount of liquid dispensed tends to vary with time and the cumulative amount of liquid dispensed. This is due, for example, to the clogging of the valve and changes in the pressure of the fluid. Another problem with HTS involves the dispensing of various reagents into the sample droplets when using a syringe needle. Ideally, the transfer process is performed quantitatively and without disturbing the sample droplet. However, the sample droplet often tends to adhere to the syringe. Additionally, certain chemical reagents, especially those stored in solution containing a percentage of an organic solvent, tend to adsorb to the outer surface of syringe needles when the needles are withdrawn from the microtiter plates in which the reagents are stored. This additional volume of compound is then transferred to the droplets along with the metered volume aspirated from the syringe, resulting in a non-quantitative transfer. Yet another problem with HTS involves the build up of static charge on the surface onto which the drops are dispensed. This causes the droplets to jump instead of being dispensed in a desired pattern.

Still further problems in HTS involve the potentially promising use of mass spectrometry to perform analysis of compounds. The ability of mass spectrometry to selectively and sensitively quantify trace levels of compounds in complex mixtures is well established. While traditional methods for performing HTS assays, including, for example colorimetric, fluorometric, and radiometric protocols have been generally successful compared to mass spectrometry they often require a large effort to develop and validate specific assays for the desired screen. Often traditional HTS assays require the use of an unnatural substrate (eg: a molecule that becomes fluorescent when acted upon by the target) or use of a secondary reaction to indirectly quantify the reaction of interest, such as enzyme-linked immunosorbent assays or radioimmunoassays.

A major limitation of the use of mass spectrometry in HTS is the generally slow speeds at which large numbers of samples can be analyzed. Unlike optical-based assays in which samples can be analyzed in parallel, mass spectrometry is a serial process in which sample must be analyzed one-at-a-time. Typically, a slow desalting step or purification step is used in mass spectrometry. Even with analysis time on the order of a minute per sample, performing hundreds of thousands or millions of biochemical assays is a very time-consuming and expensive process.

One necessary component in any high throughput mass spectrometry (HTMS) system is the need to thoroughly clean the fluidic interface between the mass spectrometer and the samples to be analyzed. If the fluidic interface is not thoroughly cleaned, residual sample or impurities from one analysis may confound the results from the next sample. The need to minimize sample carryover can be a time consuming process and may have a significant impact on the HTMS throughput.

Mass spectrometry interfaces in typical (ie: not high throughput) mass spectrometry applications use an automated syringe based injection system. The syringe is moved to a predetermined location and the desired amount of sample is aspirated into the syringe. The syringe is then moved to an injection valve and the sample is loaded into a loop. Upon actuation of the injection valve, the sample in the loop is pumped through a fluidic system either into an on-line chromatography system or directly into the source of the mass spectrometer. After analysis is completed, injection valve, fluidic system and, if applicable, the chromatography column can be flushed with an appropriate wash solvent or buffer to remove residual sample from the system. The syringe used to aspirate and inject that sample must also be washed. This is typically done by the repeated aspiration and dispensing of fresh wash solvent or buffer. Typically, washing the injection valve, fluidic system, and chromatography column can be accomplished rapidly. High-pressure pumps can be used to flush the entire system with large amounts of wash solution in a short amount of time. However, the washing of the syringe system can take much longer since it is a repetitive mechanical process.

In standard mass spectrometry applications the sample analysis time is typically on the order of minutes, providing more than enough time for the syringe to be washed during the analysis. However, in HTMS applications, it is desirable that the sample analysis time be on the order of seconds or less. In such an application the requirement of washing the syringe system becomes a major bottleneck in obtaining higher throughputs. A standard approach to overcoming this problem is to use multiple syringes that aspirate and inject several samples into a fluidic mass spectrometry or chromatography interface that sequentially analyzes those samples. The entire syringe assembly, consisting of a number of syringes, can then be cleaned in parallel. While such systems can improve on HTMS throughput by reducing the syringe washing time on a per sample basis (actual time to clean a-single syringe is unchanged) a complicated and expensive fluidic interface utilizing a large number of valves and injection ports is used.

Another problem with mass spectrometry is that it is traditionally incompatible with non-volatile buffer components (eg: phosphate buffer, tris buffer, etc) typically used in biochemical assays. These limitations have largely precluded mass spectrometry from being used as a tool in HTS.

The presence of non-volatile buffer components has a twofold effect on assay performance. First, non-volatile compounds tend to precipitate in the ion source of atmospheric pressure ionization mass spectrometers, such as electrospray ionization (ESI) or atmospheric pressure chemical ionization (APCI). Precipitates can occlude ion channels and degrade the performance of the mass spectrometer over time. New advances in ion sources utilizing orthogonal spray has minimized this effect, but has not entirely solved the problem. A more serious effect of non-volatile buffer salts is a suppression of signal from the desired analyte. Signal suppression can greatly reduce the sensitivity of an assay.

To eliminate the deleterious effects of non-volatile buffer salts, typical mass spectrometry methods require a preliminary and time-consuming step in which non-volatile and problematic compounds are, removed from the reaction mixture. This can be done as a separate desalting and sample clean-up step-performed prior to mass spectrometry analysis. Alternatively, the desalting step can be integrated into an on-line liquid chromatography step where the eluent from the chromatography column is diverted to the mass spectrometer. In such liquid chromatography-mass spectrometry (LCMS) the non-volatile buffer salts are separated from the analytes of interest via the chromatography column and these components are typically diverted away from the mass spectrometer interface. As analytes of interest are eluted from the chromatography column they can, in turn, be diverted to the mass spectrometry for analysis. These time consuming desalting and sample purification steps make the use of mass spectrometry unsuitable for HTS.

### SUMMARY OF THE INVENTION

In a first embodiment of the invention there is provided a system for high throughput screening of fluid samples. The system includes a sample aspiration tube and an injection valve. The injection valve is capable of alternatively applying a reduced pressure to a first fluid source and to a second fluid source, in each case via the sample aspiration tube, the first fluid source for filling a sample loop with samples, and the second fluid source for flushing the aspiration tube.

In related embodiments of the invention, the system may include an inline trap in fluid communication with the injection valve for capturing excess fluid aspirated from the first fluid source and all fluid aspirated from the second fluid source. The inline trap may be coupled between a region of reduced pressure and the injection valve. The system may include a fluidic circuit in fluid communication with the injection valve, the fluidic circuit for receiving a sample from the sample loop via the injection valve.

In accordance with another embodiment of the invention, a system for high throughput screening of fluid samples includes a sample aspiration tube and an injection valve. A sample loop and a fluidic circuit are in fluid communication with the injection valve. The fluidic circuit receives samples, via the injection valve, from the sample loop. An inline trap is coupled between a region of reduced pressure and the injection valve, wherein the injection valve applies a substantially continuous reduced pressure to the sample aspiration tube.

In a related embodiment of the invention, the injection valve may be capable of alternatively applying the reduced pressure to a first fluid source and a second fluid source, in each case via the sample aspiration tube, the first fluid source for filling the sample loop with a sample, and the second fluid source for flushing the sample aspiration tube.

In another embodiment of the invention, a system for high throughput screening of fluid samples includes a sample aspiration tube and an injection valve having a sample loop. The injection valve has a first position and a second position. An inline trap is coupled between a reduced pressure source and the injection valve. When the valve is in the first position the sample aspiration tube is coupled to the negative pressure source so as to aspirate a first fluid into the sample loop, the inline-trap capturing excess fluid aspirated. When the valve is in a second position the sample aspiration tube is coupled to the negative pressure source so as to aspirate a second fluid, the inline-trap capturing the second fluid.

In related embodiments of the invention, the second fluid may be a wash solution. The system may include a fluidic circuit, wherein when the valve is in the second position the sample loop is coupled to an increased pressure so as to divert the first fluid in the sample loop to the fluidic circuit.

In further embodiments related to each of the above-described embodiments, the fluidic circuit may include an analyzer for determining a characteristic of the sample. The analyzer may include a chromatography column and/or a mass spectrometer. The system may include a moving surface for moving a plurality of droplets with respect to the sample aspiration tube, each droplet including one of the first fluid and the second fluid, each droplet to be aspirated by the sample aspiration tube. The sample aspiration tube may be fixed in position relative to earth and/or the analyzer. The moving surface may be a timing belt, characterized, for example, by teeth for engagement by a sprocket. The moving surface may be reinforced with a material characterized by a strength greater than that of the moving surface. The material may be chosen from the group of materials consisting of glass, aramid, and steel. A laminate may be attached to the moving surface, wherein the droplets are deposited onto the tape.

In accordance with another embodiment of the invention, a system for high throughput screening of a plurality of droplets includes a moving surface. A tape is adhered to the moving surface. The system further includes a dispenser for dispensing each droplet onto a surface of the tape, and a means for performing on at least one droplet one or more operations from the group of operations consisting of mixing, diluting, concentrating, heating, cooling, humidifying, filtering, and analyzing.

In related embodiments of the invention, the tape includes a pressure sensitive adhesive for adhering the tape to the moving surface. The pressure sensitive adhesive may be an acrylic adhesive and may not outgas at temperatures between 0° C. and 95° C. The surface of the tape may have a surface energy lower than 31 dynes/cm or greater than 44 dynes/cm. The surface of the tape may be Teflon, polyethylene, or polyester. The moving surface may travel across a pulley, wherein the tape stretches to avoid breaking when the moving surface travels across the pulley, and the tape contracts after the moving surface leaves the pulley so as to remain adhered to the belt. The moving surface may travel in a path having a curvature, wherein the tape stretches to avoid breaking when the moving surface travels across the curvature, and the tape contracts after the moving surface passes the curvature so as to remain adhered to the belt. The curvature may have a radius of, for example, 0.5 cm or greater. The moving surface may be rubber, polyurethane, or a laminate composite. The system may further include an antistatic gun or an ionizer for removing static charge build up on the tape.

In another embodiment of the invention, a system for high throughput screening of a plurality of droplets includes a moving surface. A dispenser dispenses each droplet onto the moving surface. A syringe needle dispenses a reagent into at least one of the droplets. The syring needle is coated with a hydrophobic coating. The system also includes a means for performing on at least one droplet one or more operations from the group of operations consisting of mixing, diluting, concentrating, heating, cooling, humidifying, filtering, and analyzing.

In related embodiments, the hydrophobic coating may be, for example, Teflon, Parylene, or FluoroPel. A controller may control the syringe needle such that the syringe needle penetrates the droplet prior to dispensing the reagent. If the droplets are moving via the moving surface, the controller may control the syringe needle such that the syringe needle penetrates a leading edge of the droplet. The moving surface may travel in a defined path, with the reagent dispensed at a fixed location on the path relative to earth and/or an analyzer. The controller may remove the syringe from droplet after dispensing the reagent and before the trailing edge of the droplet passes the fixed location.

In yet another embodiment of the invention, a system for high throughput screening of a plurality of droplets includes a moving surface for transporting the plurality of droplets. At least one dispenser dispenses fluid onto the moving surface, the at least one dispenser calibrated by a controller. The system includes a means for performing on each droplet one or more operations from the group of operations consisting of mixing, diluting, concentrating, heating, cooling, humidifying, filtering, and analyzing.

In related embodiments, the at least one dispenser may be a solenoid valve that applies a pressure pulse to dispense fluid. The controller may include a feedback loop, the feedback loop including at least one sensor, which may be an optical sensor, for detecting the size of one or more droplets on the moving surface. The controller may adjust at least one parameter of the at least one dispenser, such as pressure pulse length, number of pressure pulses, and aperture size. The at least one dispenser may dispense the plurality of droplets onto the moving surface and/or a reagent into at least one of the plurality of droplets.

In accordance with another embodiment of the invention, a method for mass spectrometry sample peak integration in a high throughput screening system is presented. The high throughput screening system including an injection valve that when activated injects a fluid sample into a substantially continuous flow of wash solution being delivered, via a fluidic circuit, to an input of a mass spectrometer. The method includes recording an actuation time of the injection valve. A sample peak leading edge is calculated by adding a predetermined time delay to the actuation time. A sample peak trailing edge is calculated by adding a predetermined duration time to the sample peak leading edge. An output signal from the mass spectrometer between the sample peak leading edge and sample peak trailing edge is then integrated.

In related embodiments of the invention, the method may further include determining the predetermined time delay by injecting, via activation of the injection valve, a solution into a substantially continuous flow of wash solution being delivered to the fluidic circuit. The wash solution has an associated wash solution spectrometer signal and the solution has an associated solution mass spectrometer signal that is recognizable from the wash solution spectrometer signal. The time between when the injection valve is activated and when the solution mass spectrometer signal is received at an output of the mass spectrometer is observed. The predetermined duration time may then be determined by observing how long the solution mass spectrometer signal is observed at the output of the mass spectrometer.

In accordance with another embodiment of the invention, a method for high throughput screening of fluid samples includes applying, via an injection valve, a reduced pressure to a sample aspiration tube. A first fluid and a second fluid is alternatively aspirated via the sample aspiration tube, the first fluid for filling a sample loop with samples, and the second fluid for flushing the sample aspiration tube. Excess fluid aspirated from the first fluid source and all fluid aspirated from the second fluid source is captured in an inline trap.

In related embodiments of the invention, the reduced pressure may be applied substantially continuously to the sample aspiration tube. An increased pressure, via the injection valve, may be applied to the sample loop so as to pump each sample to a fluidic circuit. A characteristic of each sample received by the fluidic circuit may be analyzed, for example, by performing mass spectrometry and/or chromatography. The wash solution may be coupled between a region of increased pressure and the injection valve, the method further including pumping a stream of wash solution, via the injection valve, to a fluidic circuit and injecting, upon activation of the injection valve, the sample loop into the stream of wash solution, such that the wash solution flushes the sample loop and the fluidic circuit alternatively receives one of the sample and the wash solution. A plurality of droplets may be moved with respect to the sample aspiration tube, each droplet alternately including one of the first fluid and the second fluid, wherein each droplet is to be aspirated by the sample aspiration tube.

In accordance with another embodiment of the invention, a method for high throughput screening of a plurality of droplets includes adhering a laminate onto a moving surface. Each droplet is dispensed onto the laminate. One or more operations is performed on the at least one droplet. These operations include, for example, mixing, diluting, concentration, heating, cooling, humidifying, filtering, and analyzing. Static charge may be removed from the laminate prior to dispensing the droplets.

In another embodiment of the invention, a method for high throughput screening of a plurality of droplets includes dispensing each droplet onto a moving surface. A reagent is dispensed into at least one of the droplets using a syringe needle coated with a hydrophobic coating. One or more operations is performed on at least one droplet from the group of operations consisting of mixing, diluting, concentration, heating, cooling, humidifying, filtering, and analyzing.

In related embodiments, dispensing the reagent may include pushing the syringe needle into the droplet, dispensing the reagent into the droplet, and removing the syringe. The moving surface may travel along a path, and the reagent is dispensed at a fixed location along the path. The syringe needle may be pushed into a leading edge of the droplet while the droplet is moving via the moving surface, whereupon the reagent is dispensed into the droplet and the syringe needle removed from the droplet prior to the droplet moving past the syringe needle.

In still another embodiment of the invention, a method for high throughput screening of a plurality of droplets includes dispensing each droplet onto a moving surface. A characteristic of at least one droplet on the moving surface is measured. At least one dispenser is calibrated based, at least in part, on the characteristic. One or more operations is performed on at least one droplet from the group of operations consisting of mixing, diluting, concentration, heating, cooling, humidifying, filtering, and analyzing.

In related embodiments, the calibration may include adjusting at least one parameter of a dispenser, such as pressure pulse length, number of pressure pulses, and aperture size. A characteristic of the drop may be measured by performing optical imaging. A running average of the characteristic may be measured, the calibration including, at least in part, comparing the running average to a predetermined value. Measuring the characteristic may include measuring a characteristic of numerous droplets until one of a variance of the characteristic, a standard deviation of the characteristic, and a standard error of the characteristic drops below a predetermined value.

In another embodiment of the invention, a method for high throughput screening of a plurality of droplets includes dispensing each droplet onto a moving surface. A volatile buffer is added to at least one droplet. At least one characteristic of each droplet is analyzed using a mass spectrometer, wherein the only buffer added to the droplet consists of a volatile composition.

In related embodiments, no desalting is performed on the droplet prior to inputting the droplet into the mass spectrometer. The volatile buffer may include, for example, ammonium formate, ammonium acetate, ammonium carbonate, and/or ammonium bicarbonate. The pH of the droplet may be adjusted by adding to the droplet formic acid, acetic acid, propionic acid, ammonium hydroxide, and/or triethylamine. The rate at which the at least one droplet is input into the mass spectrometer may be faster than one droplet every two seconds. In various embodiments, the rate is substantially one droplet per second.

In accordance with another embodiment of the invention, a method for high throughput screening of a plurality of biochemical assays includes adding a volatile buffer to each assay and inputting each assay into a mass spectrometer, wherein the only buffer added to the assay consists of a volatile composition. The step of desalting can hence be eliminated. The volatile buffer may include ammonium formate, ammonium acetate, ammonium carbonate, and/or ammonium bicarbonate. The pH of the assay may be adjusted by adding to the assay formic acid, acetic acic, propionic acid, ammonium hydroxide, and/or triethylamine. The rate at which each assay is input into the mass spectrometer may be faster than one droplet every two seconds. In various embodiments, the rate is substantially one assay per second. The reaction may also be buffered only by proteins intrinsic to the assay such as the enzyme in an enzyme inhibition assay.

In accordance with still another embodiment of the invention, a method for high throughput screening of a plurality of droplets includes dispensing each droplet onto a moving surface. A reagent is dispensed into each droplet. One or more operations is performed on each droplet from the group of operations consisting of mixing, diluting, concentration, heating, cooling, humidifying, filtering, and analyzing, wherein no stop solution is added to the plurality of droplets. Analyzing may include performing mass spectrometry.

### BRIEF DESCRIPTION OF THE DRAWINGS

The foregoing features of the invention will be more readily understood by reference to the following detailed description, taken with reference to the accompanying drawings, in which:

FIG. 1 is a schematic of a high throughput screening system according to one embodiment of the present invention;

FIG. 2 is a schematic of a wound tape with through holes in accordance with one embodiment of the present invention;

FIG. 3 is a schematic of a system for dispensing droplets on a tape with through holes in accordance with one embodiment of the present invention;

FIG. 4 is a schematic of a system for transferring fluid from a pin array to through holes on a wound tape in accordance with one embodiment of the present invention;

FIG. 5 is a schematic of a front view of a syringe bank in accordance with one embodiment of the present invention;

FIG. 6 is a schematic of a side view of a syringe bank in accordance with one embodiment of the present invention;

FIG. 7 is a schematic of a top view of a syringe bank in accordance with one embodiment of the present invention;

FIG. 8 is a schematic showing a humidification scheme for droplets on a moving surface in accordance with one embodiment of the present invention;

FIG. 9 is a schematic of a valve assemble that removes the sample to be interrogated from the moving surface by aspiration in accordance with one embodiment of the present invention;

FIG. 10 is a schematic of the valve assembly of FIG. 10 when the sample is being aspirated in accordance with one embodiment of the present invention;

FIG. 11 is a schematic of the valve assembly of FIG. 10 when the sample is being presented for mass spectrometry in accordance with one embodiment of the present invention;

FIG. 12 is a schematic of a piezo-electric unit assembly that removes the sample to be interrogated from the moving surface by aspiration in accordance with one embodiment of the present invention;

FIG. 13 is a schematic of a piezo-electric unit assembly dispensing a sample in a stream of very small droplets towards the inlet of a mass spectrometer in accordance with one embodiment of the present invention;

FIG. 14 is a schematic of a piezo-electric unit assembly dispensing a sample in the form of a stream of micro-droplets to a surface proximal to the inlet surface of a mass spectrometer in accordance with one embodiment of the present invention;

FIG. 15 is a schematic of a piezo-electric unit assembly dispensing a sample in the form of a high speed stream of micro-droplets at the point of a sharp pin or needle towards the inlet of a mass spectrometer in accordance with one embodiment of the present invention;

FIG. 16 is a schematic of a piezo-electric unit assembly dispensing a sample in the form of a high speed stream of micro-droplets at a fine mesh towards the inlet of a mass spectrometer in accordance with one embodiment of the present invention;

FIG. 17 is a schematic of a piezo-electric assembly dispensing a sample in the form of a high speed stream of micro-droplets at a hole in a parabolic mirror towards the inlet of a mass spectrometer, the stream being collinear with a light beam from a laser, in accordance with one embodiment of the present invention;

FIG. 18 is a schematic of a system for rapidly heating samples on a moving surface so as to cause atomization in accordance with one embodiment of the present invention;

FIG. 19 is a schematic of a system for forcibly ejecting a sample from a moving surface in accordance with one embodiment of the present invention;

FIG. 20 is a schematic of a system for rapidly vibrating samples on a moving surface so as to cause atomization in accordance with one embodiment of the present invention;

FIG. 21 is a schematic of a system for rapidly vibrating samples on a moving surface so as to cause atomization using a vibrating probe, in accordance with one embodiment of the invention;

FIG. 22 is a block diagram of a high throughput screeningsystem architecture, in accordance with one embodiment of the invention;

FIG. 23 is a flowchart for a method of tracking droplets, in accordance with one embodiment of the invention;

FIG. 24 is a graph of an α-Chymotrypsin assay performed in ammonium acetate buffer during HTS, in accordance with one embodiment of the invention; and

FIG. 25 is a graph of a 15-Lipooxygenase assay performed in ammonium acetate during HTS, in accordance with one embodiment of the invention.

### DETAILED DESCRIPTION OF SPECIFIC EMBODIMENTS

Definitions. As used in this description and the accompanying claims, the following terms shall have the meanings indicated, unless the context otherwise requires: A droplet may be referred to herein and in the appended claims as a “microdroplet” or a “sample,” and may include droplets containing living cells, such as yeast cells, for example, and may, more particularly, include droplets carrying a single living cell per droplet.

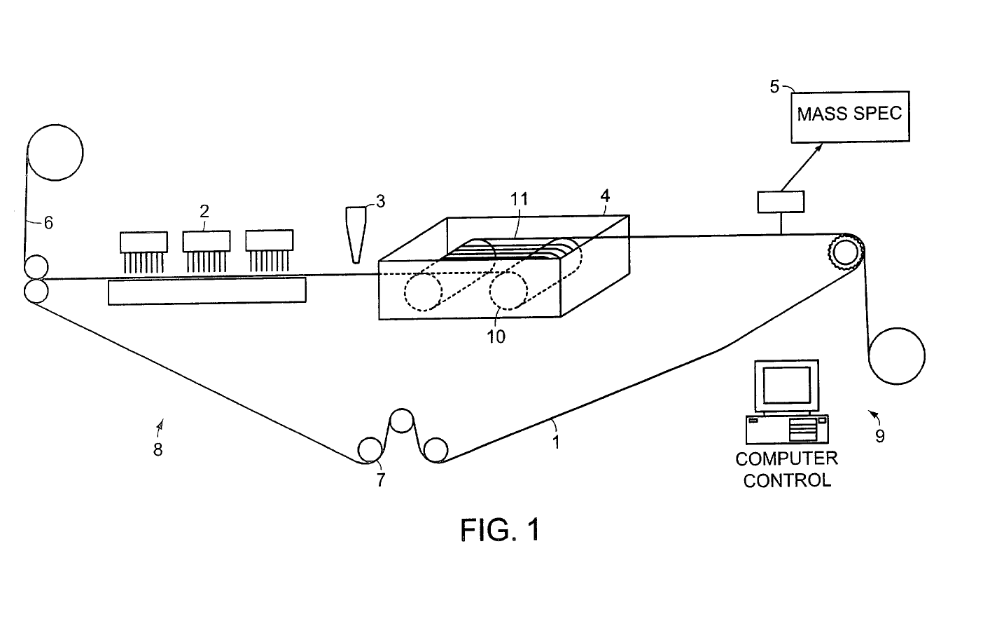

FIG. 1 is a schematic of a High Throughput Screening (HTS) system 8 according to one embodiment of the invention. The system includes a moving surface 1, a compound reformatter 2, a reagent addition station 3, an environmental delay chamber 4, computer control 9, and at least one analyzer, such as a mass spectrometer 5, for example. Each of these elements in the system will now be covered in detail.

The Moving Surface

As shown in FIG. 1, moving surface 1 connects various components of the HTS system 8 together. Moving surface 1 may be a fiber, belt, tape, conveyor, or web, which, while used interchangeably throughout this document, may advantageously be chosen for particular applications. While the moving surface 1 may simply act as a transport mechanism, in preferred embodiments of the invention, the moving surface 1 also plays an active part in the assay physics or chemistry, such as binding, separation, or filtration. The moving surface 1 may be of homogenous material, such as rubber or polyurethane, or it can be a multilayer composite with a surface specifically designed for a specified assay to be performed. Additionally, moving surface 1 can take the form of a fiber.

In a preferred embodiment of the invention, moving surface 1 is similar to a timing belt that may have, for example, teeth for engagement by a sprocket such that accurate and robust positioning of the belt is facilitated. To allow for more precise positioning, the moving surface 1 may be made advantageously resistant to stretching. The moving surface 1 may be reinforced with a material having a strength greater that that of the moving surface, particularly in embodiments in which the moving surface is under stress, such as, when the moving surface 1 is used in a pulley system. Reinforcement materials may include, for example, glass, aramid, or steel. Moving surface 1 may move continuously, or with a discontinuous start/stop action.

While moving surface 1 may be of fixed length, being unwound from an unwind station as required, and with splices employed when more length is required, moving surface 1 may also be joined end to end, as shown in FIG. 1. In this manner, splices are not required when additional length is needed, and uniform tensioning is facilitated.

In order to provide a surface that is optimized for the assay in question, in various embodiments of the invention moving surface 1 is designed such that the top surface is physically, chemically, or biologically active. Alternatively, the surface can be prepared online, such as by corona treatment.

In a preferred embodiment of the invention, a laminate 6 is applied to the moving surface 1. Laminate 6 may be permanently bonded to moving surface 1. Alternatively, laminate 6 may be attached temporarily to the moving surface 1 for removal at a later time. Laminate 6 may be a tape that is made of, for example and without limitation, polyethylene or Teflon. The tape may have a surface that includes a pressure sensitive. adhesive for adhering the tape to the moving surface 1, the pressure sensitive adhesive characterized in that increasing pressure applied to the tape results in increased adhesion between the tape and the surface. The adhesive may be an acrylic adhesive that has high initial tack, but does not develop too much adhesion (particularly during exposure in the environmental delay chamber 4) so as to prevent the tape from being reliably removed at the end of the process. The moving surface 1 preferably has a smooth surface to allow clean release of the tape at the end of the process. The adhesive material may be selected so as to advantageously not outgas, particularly at temperatures experienced in delay chamber 4, which may be between, for example, 0° and 65° Celsius.

As shown in FIG. 1, tape 6 may be spooled to the top surface of a moving belt 1, and removed and rewound after analysis is complete. In this manner, a new assay surface can be applied and removed after use. After removal, the laminate may either be cleaned and reused, or disposed of. This can be beneficial for several reasons, including, but not limited to, allowing the top surface of moving surface 1 to be easily and quickly customized for each assay performed.

To remove any static charge build up on the laminate 6 during the lamination/spooling process, which may cause droplets dispensed from a syringe bank 2 to jump instead of being dispensing in a desired pattern, an antistatic gun or ionizer may be used. One such ionizer ionizes the air using alpha particles, for example. In preferred embodiments of the invention, the ionizer is placed in proximity to the moving surface 1, after the lamination and before the dispensing stations.

Laminate 6 can be customized for numerous surface properties (as can the moving surface 1 if no laminate is applied). These properties include, but are not limited to, cleanliness, biocompatibility, surface energy, binding affinity, separation, porosity, chemical addition and interaction, sample information encoding and tracking, viscoelasticity, and the addition of surface features.

Cleanliness and Biocompatability

Surface cleanliness and biocompatibility are critical for assay quality. The active surface of laminate 6 (ie. the surface upon which sample droplets are dispensed) may include a biocompatible surface such as, but not limited to, Teflon, polypropylene, or polyethylene. Furthermore, the active surface of laminate 6 can be such that it is easily washable after application. This is important if the active surface of laminate 6 is contaminated as received or if it is to be recycled through the assay system.

Surface Energy

In accordance with various embodiments of the invention, the active surface of laminate 6 is chosen to have a low surface energy to localize the aqueous sample drops and minimize spreading, or a high surface energy to maximize spreading and contact with the tape. ‘Surface energy,’ in this context, refers to wettability. Laminate 6 may have a surface energy of lower than, without limitation, 31 dynes/cm. For example, laminate 6 may be made of made of Teflon or polyethylene, which have a surface energy of approximately 20 dynes/cm and 30 dynes/cm, respectively. Alternatively, laminate may have a surface energy of 44 dynes/cm or higher, and be made of polyester, for example.

Additionally, the active surface of laminate 6 may have a uniform surface energy, or a pattern of surface energies such as hydrophilic spots on a hydrophobic background that serves to promote drop adhesion as well as minimize drop migration. This pattern can be pre-existing on the active surface of the laminate 6, or applied to the surface inline, such as by lamination or by localized corona discharge devices. Applying the pattern inline obviates the need for pre-registering the laminate 6 with the drop placement, as the surface energy pattern is applied in a pattern registered with the drop dispensing.

Binding

The active surface of the laminate 6 may be prepared, either uniformly or spatially distributed, with a surface that binds, selectively or non-selectively, to molecules in the assay sample. In this manner, heterogeneous processes such as washing or Fluorescence In-Situ Hybridization (FISH) can be performed. For example, washing can be accomplished by passing the laminate 6 through a wash bath and removing the unbound components of the droplet. Sample coatings that can be used and that are known in the art include streptavidin and biotin.

Separation

In various embodiments of the invention, laminate 6 is magnetic, either by being magnetic material or by passing over a magnet, to allow the use of magnetic bio-separation beads or other devices. The beads can be added to the droplet to bind molecules of interest, which then attach to the laminate through magnetic interaction. The droplet,can then be washed, in a bath or otherwise, with the beads and molecules of interest still fastened to their original location on laminate 6. The use of a flexible magnetic strip may be advantageously used as a magnetic surface for laminate 6. The strip is made up of tiny individual magnets dispersed in a polymeric binder. This provides magnetic flux gradients that capture the beads in place, whereas a uniformly magnetized surface would capture the beads but allow them to migrate on the surface across the uniform magnetic field. The flexible magnetic strip may be permanently magnetized, such as the “refrigerator magnet” type strip, or be temporarily magnetized, such as high quality metal particle recording media. The flexible magnetic strip also has the advantage that sample information can be written next to the sample droplet on the tape for later identification or to facilitate analysis. Magnets may also be used to drag all or portions of the magnetic beads in a sample off of the tape for further analysis.

Porosity

In another embodiment of the invention, either the entire active surface, or part of laminate 6 is made porous. This increases the contact area of the droplet with the derivatized surface, so as to minimize the exposure the droplet has with the atmosphere, or for filtration. The pores can be through the depth of the tape, or only a fraction thereof. The pores can be isotropic or anisotropic. In one embodiment of the invention, the pores of laminate 6 are oriented perpendicular to the surface and travel only a fraction of the film thickness. The allows sample penetration beneath the surface while minimizing sample spreading. A porous surface also serves to increase the surface area, which can increase its affinity for specific components of drops, especially when the surface is derivatized with molecules having an affinity for components of the reactions.

Chemical Addition

In accordance with one embodiment of the invention, the active surface of the laminate 6 can be prepared uniformly or in a spatially patterned manner with one or more chemicals designed to participate either chemically or physically in the assay.

For example, laminate 6 can be coated with a surfactant such that upon addition of the sample, the surfactant diffuses to the surface of the sample drop to help retard evaporation. Suitable materials for this example include, but are not limited to, fatty acids and fatty alcohols such as dodecanol.

Other examples include, but are not limited to, coating laminate 6 with a MALDI matrix to enable the ionization of the sample components or their reaction products, or coating laminate 6 with Ion-exchange resin or with affinity-labeled beads.

Elasticity, Stretchability, and/or Resiliency

The laminate 6 may be selected so as to be elastic, stretchable, and/or resilient. For example, in various embodiments, moving surface 1 may travel in a path having a curvature, such as when the moving surface 1 moves across a pulley. This curvature may be, without limitation, 1-10 cm in diameter. In such embodiments, a tape laminated onto the moving surface is preferably stretchable to avoid breaking when moving across the curvature of the pulley, and resilient so as to contract and remain adhered to the moving surface after passing across the curvature. Furthermore, the tape is preferably elastic so as to be able to recover from deformations that occur during use.

Surface Features

The active surface of the laminate 6 may incorporate surface features such as cups or indentations, tube holders, holes, and funnels. Another laminate 6 may also be applied to the surface, in particular, a surface with cups, to act as a lid to prevent sample contamination and provide environmental control.

An efficient HTS system 8 requires physical operations to be performed both in a serial (time sequential) and parallel manner. As is known in the art, a two-dimensional array of through holes can be rapidly loaded in parallel by dipping the array into a bulk solution. Additionally, reactions can be initiated in parallel by stacking two co-registered through-hole arrays one on top of the other. However, the loading and removal of fluids from different through holes in the array is fundamentally a serial process, and the time required to accelerate and de-accelerate a through hole array relative to a dispensing or aspirating tube requires an undue amount of time. Accordingly, moving surface 1 may advantageously take the form of a two-dimensional array when wound, and a one-dimensional array when unwound. Fluids can then be dispensed or removed from the one-dimensional array in a time-sequential (serial) manner, and when desired, the one-dimension array can be reconfigured into a two dimensional array for storage or to conduct parallel operations, such as dip loading, mixing, and optical-based read-out. Additional serial operations, include, but are not limited to, interfacing to an inherently serial analyzer (e.g. mass spectrometer) or interfacing to a compound library stored in microtiter plates.

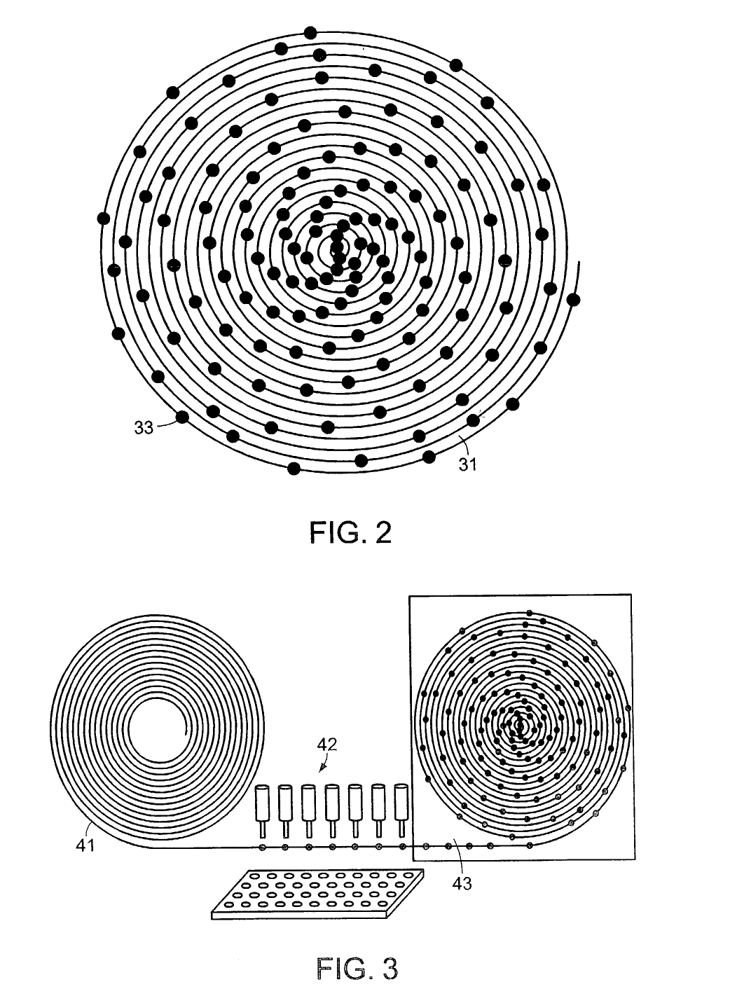

In accordance with one embodiment of the invention, moving surface 1 and/or laminate 6 (hereinafter laminate shall be used for this embodiment) can be wound, as a spiral for example, and unwound, acting as an improved microtiter plate. Laminate 6 may be, but is not limited to, a tape, fiber, or belt. The laminate 31 includes through holes 33 perpendicular to its width, which serve as containers to hold sub-microliter volumes of fluid, as shown in FIG. 2. Through holes 33 may be machined into the surface, (for example formed from the surface geometry itself, or capillary tubes may be attached at intervals along the length of the surface. Through hole containers 33 are preferably at equally spaced intervals along the length of the surface. Laminate 31 may be wound such that the through holes 33 are perpendicular to the plane of the tape and the through-holes 33 form a known geometric pattern. In a preferred embodiment the through-hole 33 center-to-center spacing is an integral multiple of the well-to-well spacing in a 96-, 384- or 1536-well microtiter plate. Compounds stored as fluids in a microtiter plate are transferred into through-holes 33 by a bank of syringes having a center-to-center spacing an integral multiple of the well spacing in the plate. As shown in FIG. 3, the laminate 41 is unwound and passed beneath the syringe dispensing head 42, whereupon known amounts of fluid are dispensed into each through-hole 43 and laminate 41 is advanced. With two syringe banks and simple automation, fluids can be transferred and loaded into laminate 41 through holes 43 at a rate exceeding one compound per second. Instead of syringes, pins or quills may also be used for the fluid transfer. After fluid loading, laminate 41 may be spooled in a temperature and humidity-controlled chamber to minimize evaporation of the loaded fluids. The high aspect ratio of through-holes 43 serves to slow fluid loss from evaporation because of the small surface area-to-volume ratio.

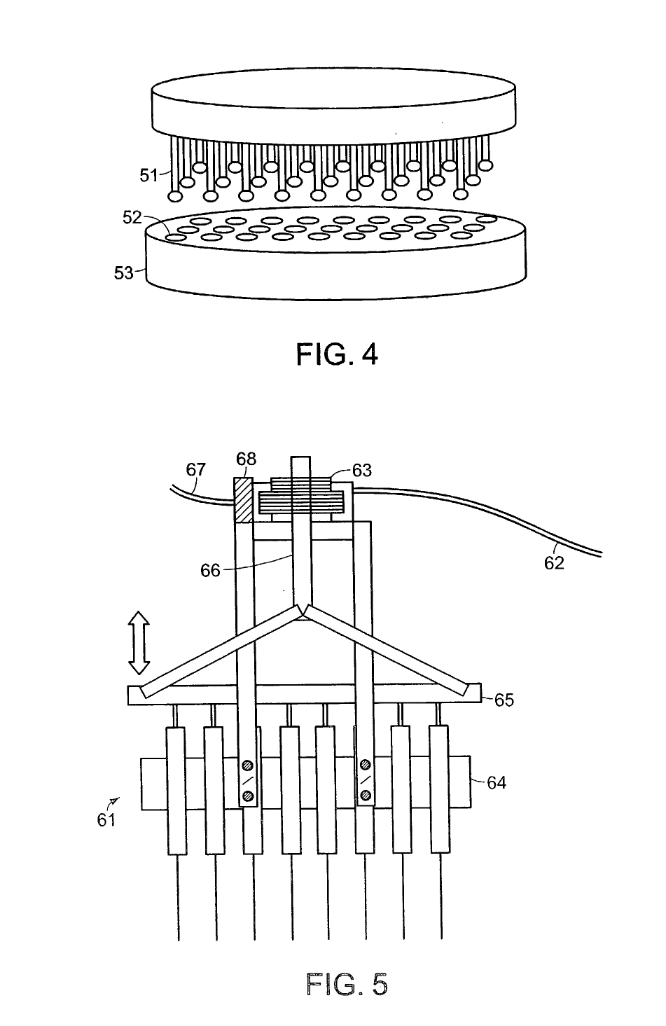

As shown in FIG. 4, once a compound library is loaded, a two-dimensional array of pins 51 having the same two-dimensional geometry and center-to-center spacing of the through-holes 52 may be dip loaded with reagent, co-registered with respect to the laminate through-hole array 53 and brought into proximity of through-holes 52 such that fluids are transferred from the pins to through-hole 52. In this manner, reagents are loaded and reactions initiated simultaneously in a massively parallel manner. Cells may also be placed in the through holes and cell-based assays performed. The laminate through-hole array 53 may be placed in a temperature and humidity-controlled environment for a prescribed length of time after which a stop reagent is added to through-holes 52 in a manner similar to the addition of the reaction reagents. The laminate through-hole array 53 is unwound and the reaction products in each through-hole 52 are sampled and analyzed, for example, by being injected sequentially into a mass spectrometer for analysis. Additionally, if the assay read-out is optical-based then each through-hole 52 is optically analyzed in parallel (i.e. imaged) and then read-out sequentially with the mass spectrometer.

The Compound Reformatter

In accordance with one embodiment of the invention, the library samples to be screened are reformatted from the plates to the surface of the moving surface by a compound reformatter 2, as shown in FIG. 1. Reformatter 2 may include a robotic arm that selects a plate from a storage system and places it within access of the moving surface 1 in a defined location. A microsyringe or a bank of microsyringes on a xyz stage transfers a sample compound from a well to the surface of the tape 6. Repeating this operation results in an array of drops on the moving tape 6. Because the rate of movement of the tape 6 and/or its position is accurately known, the position and identification of the drop is known, and subsequent reagent additions and analysis can be performed on specific drops later in the high throughput process. The drops are spatially isolated from each other on the tape so that no cross contamination can occur. Preferably, the drops are 1 μl or less to minimize compound usage and so that surface tension forces exceed gravitational forces and the drops stick to the tape 6 regardless of its orientation. Note that in addition to, or instead of a microsyringe(s), piezo or bubble jet heads, solenoid valves (that apply, for example, pressure pulses to eject samples), quills, and/or pins may be used alone or in an array to transfer samples to the tape.

In one embodiment of the invention, a bank of microsyringes is used instead of one microsyringe. For example, 8 or 12 microsyringes in a row with 9 mm tip-to-tip spacing in a bank can be used to facilitate transfer from commercial 96 and 384-well microtiter plates. A multipipettor approach may be advantageously utilized because it creates time between dispensings that can be used for washing the pipettes and transporting the microtiter plates.

FIGS. 5, 6, and 7 show a front view, side view, and top view, respectively, of a syringe bank system 61 in accordance with one embodiment of the invention. A flexible coupling 62 or linkage transmits torque to the plunger drive gear 63, allowing the torque source, which may be a stepper or servo motor, to be remotely mounted. This greatly reduces the mass of the syringe bank assembly 64 when compared to a design that incorporates the motor on-board. Consequently, the overall assembly has little inertia relative to current designs and therefore requires less power to accelerate when attached to a positioning system. Greater accelerations can also be achieved for a given amount of applied force.

In various embodiments of the invention, a rack and pinion gearing 63 system is used to transform the rotary motion supplied to the syringe assembly 64 by the motor and coupling into a linear motion, which would then drive the syringe plungers in and out. To combat backlash error a pair of racks attached to the plunger assembly 65 may be used. By mounting the rack gear pieces 66 slightly translated in the direction of their length with respect to each other backlash between the drive pinion 63 and plunger rack 66 may be ‘taken up’ at assembly time.

An alternative gearing scheme could be incorporated such as a worm gear driving a threaded rod. The plunger bar 65 would be driven by either threading the rod through a part of the plunger assembly or rigidly attaching the threaded rod to the plunger assembly 65 and threading the rod through the center of the worm gear. Either scheme requires mechanically constraining the plunger assembly to vertical translations. A worm gear configuration allows for a higher over all gear ratio to be achieved between the drive system 63 and the plunger assembly 64. It also has the virtue of being un-back drivable, that is, the plunger assembly 64 would be self-locking and no torque would be required to hold the plunger assembly 64 in place.

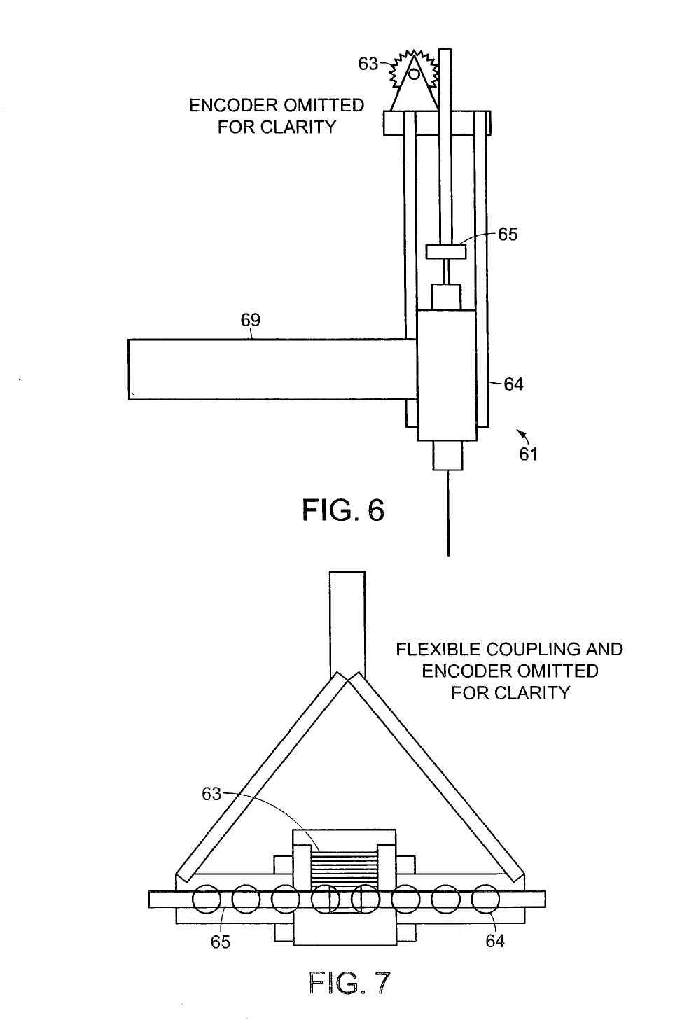

In other embodiments of the invention, a rotary encoder 68 that is controlled externally 67 is attached to the drive gear axis 63 that drives the plunger assembly 64. By using rotary encoder 68, precise metering of the fluid can be achieved as it dispensed from the syringes. Additionally, a connector bar 69 may be used to position the syringe bank system 61, as shown in FIG. 6.

The syringe bank component is modularized such that one may choose various methods of translating the syringe bank from the microtiter plates to the laminate. One possible configuration would be a 2-axis gantry that allows precise positioning in a plane. Additionally, in various embodiments of the invention, two syringe banks on a gantry could be utilized such that one bank could be collecting samples from a plate and dispensing while the other bank is being washed.

The adjustment may be automated and/or done manually. Parameters that may be adjusted include, without limitation, pulse length, number of pulses, pressure, aperture of the opening or any other factor that affects the amount of liquid dispensed.

Reagent Addition Station(s)

In accordance with one embodiment of the invention, one or more reagent addition stations 3, as shown in FIG. 1, can be placed anywhere along the moving surface 1, but are typically placed downline of the Compound Reformatter 2. Reagents may consist of buffers, reactant, substrates, beads, solids, slurries or gels. The reagents may be dispensed in drops by coordinating the timing of the dispensing with control of the moving surface 1 such that they are added to the same positions as other drops, thus causing reagents to mix and form a single, larger drop. Mixing occurs while each drop-holding domain remains spatially isolated from one another, each drop being a separate assay reaction. Reagent addition station(s) 3 typically include a microsyringe or an array of microsyringes, however other dispensers, such as solenoid valve(s) and/or piezo dispensing head(s) can also be used.

Typically, it is beneficial that the transfer of the reagent to a droplet be performed in a quantitative manner, and without disturbing the placement of the droplet on the active surface of the laminate 6. Certain chemical reagents, especially those stored in solution containing a percentage of an organic solvent, tend to adsorb to the outer surface of syringe needles when the needles are withdrawn from the microtiter plates in which the reagents are stored. This additional volume of compound is then transferred to the droplets along with the metered volume aspirated from the syringe, resulting in a non-quantitative transfer. To overcome this problem, the exterior surface of the syringe may be covered with a hydrophobic coating, which helps prevent reagents from adsorbing to the outer surface of the syringe needle. Hydrophobic coatings include, without limitation, Teflon, Parlyene, and FluoroPel.

To further facilitate the quantitative transfer of reagent into a droplet, the transfer of reagent from the syringe into the droplet may be achieved by plunging the tip of the needle into the droplet. The reagent is then dispensed from the syringe(s) directly into the droplet by depressing the syringe plunger. After the dispensing operation is complete, the syringe is moved out of the droplet. The hydrophobic coating of the exterior of the surface prevents the droplet from adhering to the syringe while removing the syringe. In addition to facilitating a quantitative transfer of the reagent into the droplet, transferring the reagent in this manner also allows for rapid mixing of the reagent within the droplet.

The above described dispensing operation may occur while the droplet is moving. For example, the droplets may be continuously transported by the moving surface along a defined path, with the syringe dispensing the reagent into the droplet at a fixed position on the path. In such embodiments, the syringe may be plunged into a leading edge of the droplet. After the reagent is dispensed from the syringe into the droplet, and prior to the trailing edge of the droplet moving past the syringe, the syringe is then preferably removed from the droplet. This helps to minimize any possible disruption of the droplet's position on the moving surface, and further ensures a quantitative transfer. Since in HTS the droplet may be positioned under the syringe for a relatively short period of time, in some embodiments on the order of milliseconds, the syringe may be attached to an automated robotic motion control system, which may be computer controlled.

Note that when dispensing liquid via a solenoid valve or similar device, the amount of liquid dispensed tends to vary with time and the cumulative amount of liquid dispensed. This may occur, for example, due to clogging of valves and changes in the pressure of the liquid. In such embodiments of the invention, a controller having feedback control may be used to recalibrate the dispenser. The size of the droplet dispensed, or another characteristic of the droplet, is measured and parameters of the dispenser can be adjusted accordingly.

Methods for measuring the drop size include, without limitation, optical imaging of the droplet size and/or shape as with a digital camera, or measuring optical properties such as reflectance of the drop as it moves past a sensor. For example, fixed laser-diode containing confocal optical sensors may be used to measure the length of the droplets from the reflectance signal that is generated as the droplets move past the sensors, and the length will be correlated with the droplet size. Because of fluctuations in the drop size and error in the measurement, it may be preferable to measure numerous drops until the variance, standard deviation or standard error of the measurements drop below a pre-determined value, whereupon the dispenser can then be calibrated. The calibration may include comparing a running average of the measurements, or the most current measurement, to a pre-determined value. The process may be repeated to maintain a stable drop size.

In various embodiments of the invention, a solid-phase synthesis is performed on laminate 6. Analysis of desired properties can then be performed immediately, or laminate 6 may be rolled up and stored as a spool or cassette. Typically, to perform solid phase synthesis, a linker molecule is strongly attached to a solid support and presents a potentially reactive species to a reagent containing liquid that is contacted with the solid support. The linker may be attached directly to laminate 6, to pores in laminate 6, or to particles or gels attached to laminate 6. As laminate 6 advances past various dispensing or washing stations, reagents may be added to accomplish chemical synthesis. If each station is capable of dispensing more than one type of reagent, a combinatorial synthesis may be accomplished. Such a combinatorial synthesis would be under control of a computer 9 that would create the pattern of chemical additions to create a useful chemical diversity. Reagents that may be added include any reagents typically used in a chemical synthesis including, but not limited to: monomers, catalysts, activators, blocking agents, de-blocking agents or polymers. Standard methods of synthesis of biopolymers such as peptide, nucleic acids and carbohydrates may be used. After synthesis, the product may be liberated from the surface of laminate 6 or other support by standard means such as the use of a chemically or photolabile linker. The properties of molecules synthesized may be determined by the output of functional assays performed directly on laminate 6.

Additionally, many types of chemical assays require sample preparation and cleanup prior to chemical analysis. This cleanup can range from relatively simple operations such as desalting or complex procedures such as the removal of contaminants, impurities, or excess reagents. A common method for sample clean up and preparation is the use of solid-liquid extraction using an insoluble matrix with appropriate chemistry. Types of insoluble matrices may include beads or gels of an insoluble material such as sepharose, silica, cellulose, or polymeric matrices. The insoluble phases may or may not have a surface coating that may be of hydrophobic, hydrophilic, or ionic character depending on the necessary application. Additionally, the insoluble matrix may be conjugated to or incorporate a paramagnetic particle (eg: iron oxide). In accordance with one embodiment of the invention, sample clean-up and preparation prior to or as part of a chemical reaction or analysis is performed on laminate 6. The appropriate insoluble matrix is added to the sample at one or more positions along the surface of laminate 6 in the form of a slurry or suspension. Sample impurities such as salts or other contaminants will then selectively bind to the insoluble matrix. In various embodiments of the invention, the impurities can be removed from the sample by allowing the matrix to settle onto laminate 6 while the liquid phase is interrogated with spectroscopic or spectrometric chemical analysis. Alternatively, the insoluble phase is conjugated to a paramagnetic bead that can then be selectively removed from the sample with the application of a magnetic field. In another embodiment of the invention, the sample of interest selectively binds the insoluble phase that incorporates a paramagnetic particle, while salts or impurities remain in the liquid phase. The insoluble phase with the adsorbed sample can be immobilized to laminate 6 with the application of a magnetic field. The liquid phase containing salts or contaminants can then be aspirated off of laminate 6 and the sample can be washed with an appropriate buffer or chemical. Finally, the sample can be desorbed from the immobilized matrix with the addition of yet another buffer of the appropriate type. Desorption of the sample from the insoluble matrix may include the addition of a variety of organic solvents or buffers with appropriate ionic strength, heating or cooling the sample, photochemistry, electrochemistry, or combinations of these methods.

To eliminate time consuming desalting and purification steps prior to HTS mass spectrometry, the use of non-volatile buffer components, such as salts or ion-pairing agents, is eliminated and replaced with volatile buffer components, in accordance with one embodiment of the invention. This elimination of the desalting and purification steps allows mass spectrometric analysis of large numbers of biochemical assays to be performed at rates generally limited only by the throughput rate of the sample injector. The throughput rates achievable are much faster than previous mass spectrometry involving biochemical assays. For example, and not meant to be limiting, biochemical assay throughput rates of between one sample/two seconds and one sample/second have been achieved using electrospray ionization mass spectrometry with automated injectors (described in more detail further below). Thus, by using only volatile buffers, a plurality of droplets may be deposited on a moving surface at a rate substantially equivalent to the input rate of the sample injection system. Various operations may then performed on each moving droplet, as described in above embodiments, and the droplets serially input into a mass spectrometer without decreasing the speed of the moving surface due to desalting and/or purification steps.

Volatile salts that may be used include, but are not limited to, ammonium formate, ammonium acetate, and ammonium carbonates. The necessary buffer pH may be adjusted with the addition of appropriate amounts of volatile acids or bases including, without limitation, formic acid, acetic acid, propionic acid, ammonium hydroxide, and/or triethylamine. Typically, the amount of the salts used in the buffers is minimized, preferably to to 20 mM or less. Higher salt concentrations may be used, but ion suppression effects may be observed in some applications at higher concentrations.

The use of volatile buffers as opposed to involatile buffers is applicable to various types of mass spectrometry, including, without limitation, electrospray ionization mass spectrometry and matrix-assisted laser desorption ionization (MALDI) mass spectrometry. Precipitation of non-volatile buffer salts in the ion source is not a serious issue in MALDI-MS since the sample is typically already in solid form deposited on a metal target. However, ion suppression due to non-volatile salts can cause a high degree of signal suppression. The signal suppression can be minimized with the proper selection of volatile buffers used in the assay, as described in the above embodiments.

It is to be understood that the replacement of nonvolatile buffers with volatile buffers may not be compatible with the totality of all biochemical assays with relevance to the pharmaceutical or therapeutic application areas. However, a large subset of assays may be modified as such to allow for increased HTS rates using mass spectrometry.

Two examples which involve the elimination and replacement of nonvolatile buffers with volatile buffers with regards to HTS follow:

### EXAMPLE 1

α-Chymotrypsin is a protease that cleaves proteins and peptides at aromatic amino acids such as phenylalanine, tyrosine, and tryptophan. The example assay attempts to discover inhibitors of α-chymotrypsin. Several optical assays for α-chymotrypsin have been developed and are commercially available. These assays involve a peptide that has been derivatized with a fluorescent molecule. Upon clevage by chymotrypsin, the fluorophore is released and the fluorescence signal of the sample upon excitation by light at the appropriate wavelength is increased. Protocol for the commercially available assays use phosphate buffered saline (PBS) or Tris-HCl buffer as the reaction mixture. The major limitation of this assay system is that the natural biological substrate for α-chymotrypsin is not being used in the assay. Rather, the natural peptide product is derivatized with a fluorophore to satisfy the requirements for an optical-based assay system.

The example assay attempts to perform an assay for α-chymotrypsin using natural, underivatized substrates. Mass spectrometry was used to directly determine the relative amounts of substrate and product in each sample. On-line high performance liquid chromatography-mass spectrometry (HPLC-MS) was performed to analyze each sample and the masses of the substrate and the product peptide were monitored. An aliquot of the assay mixture was loaded onto a reverse phase chromatography column and washed with a solution of 10 mM ammonium acetate. The substrate and product peptides bind to the chromatography column under these conditions, and the column eluate containing non-volatile salts was diverted to waste. After the non-volatile salts and other contaminants have been completely removed from the sample, the column eluate is diverted from waste to the mass spectrometer. The amount of organic solvent in the solution washing the chromatography column was then slowly increased until the conditions in which the substrate and product peptides no longer bind to the chromatography column were reached. When the substrate and product peptides elute from the chromatography column to the mass spectometer, they are identified by their masses and the relative abundance of each species is recorded. Analysis time including the time to equilibrate the chromatography column between samples was roughly three minutes per sample.

The rate-limiting step in the HPLC-MS analysis is the chromatography and sample cleanup. This slow and serial analysis makes optical assays in which samples can be analyzed in parallel attractive, even though they may use unnatural substrates or use indirect analysis methods. To avoid this, the same assay was repeated, but this time the PBS reaction buffer was substituted with 10 mM ammonium acetate buffer in water. No other changes to the assay were made. After the reaction was complete, an aliquot of each sample was analyzed by direct mass spectrometry injections. No sample clean-up or chromatography on the sample was performed. A solution of 1:1 water:acetonitrile was pumped into the mass spectrometer into which a loop injection of an aliquot of the sample was done and the sample analysis was performed. The elimination of the chromatography step allowed for much faster analysis times. In this case the rate-limiting step was simply the speed at which the samples could be injected into the mass spectrometer.

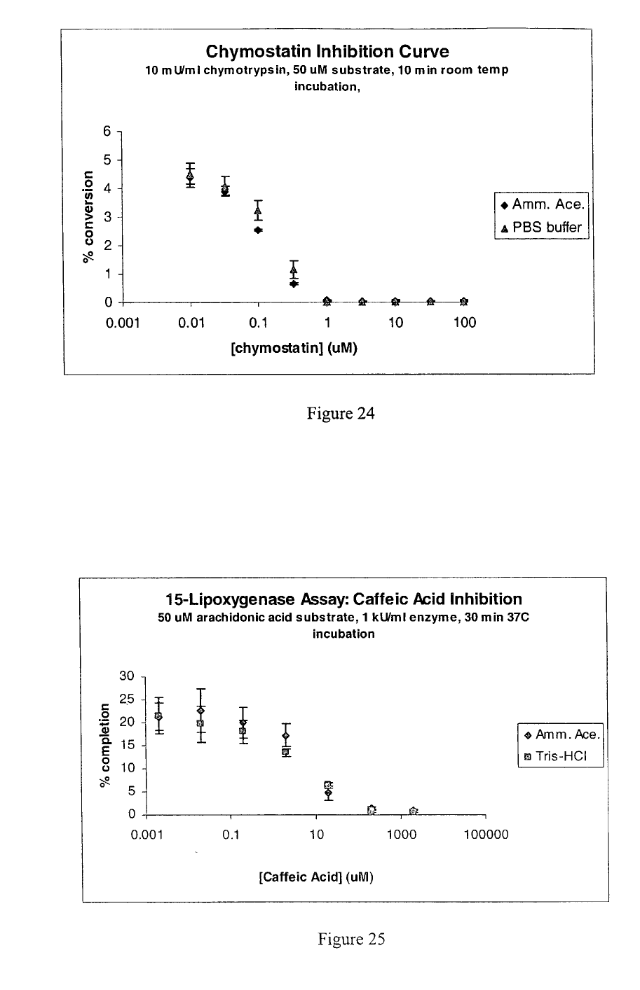

The results from these assays are shown in FIG. 24. Each reaction was performed in triplicate. Error bars represent one standard deviation. As can be seen, the data is very similar in both cases. The calculated IC₅₀ values are 0.014 and 0.021 micromolar in ammonium acetate and PBS buffers, respectively. Although the process can be completed at much faster throughput, the data obtained replacing the use of the nonvolatitile buffers with the volatile buffer is similar to data obtained using a conventional assay.

### EXAMPLE 2

A high throughput mass spectrometry-based assay to determine the IC₅₀ for an inhibitor of 15-lipoxygenase was developed. 15-lipoxygenase is an enzyme that catalyzes the specific hydroxylation of arachidonic acid to form 15(S)-HETE. Both substrate and product of the assay can easily be monitored by negative ion electrospray ionization mass spectrometry (ESI-MS). An assay replacing non-volatile buffers with volatile buffers was developed for the high throughput mass spectrometric analysis of inhibitors. The results of this invention were compared to those obtained by conventional HPLC-MS measurements.

Arachidonic acid was used as the substrate at a concentration of 50 □M. Caffeic acid (3,4-dihydroxycinnamic acid) is a known inhibitor of lipoxygenases and was used in this assay. A 7 point log dilution of caffeic acid starting from 2 mM was made and the reaction mixtures were incubated for 30 minutes at 37° C. 50 mM Tris-HCL buffer (pH 7.4) and 10 mM ammonium acetate buffer were used as the two conditions in this assay. Tris-HCl buffer is the traditional assay buffer used for this assay and required desalting of the sample prior to analysis by online HPLC-MS. The time consuming desalting step was not performed in the ammonium acetate buffer samples and direct injection of aliquots of each sample into the mass spectrometer were performed, greatly increasing assay throughput.

The results from these assays are shown in FIG. 25. Each reaction was performed in triplicate. Error bars represent one standard deviation. The results are very similar in both assay conditions. The calculated IC₅₀ values are 5.93 and 5.24 micromolar in ammonium acetate and PBS buffers, respectively. Data obtained using the current invention developed specifically for high throughput mass spectrometric analysis is similar to data obtained using a much slower conventional assay.

Environmental/Delay Line/Incubation Chamber and Evaporation Control

In accordance with another embodiment of the invention, the droplet may be transported, via the moving surface/laminate, through a controlled environment prior to analysis, as shown in FIG. 1. In various embodiments of the invention, the environmental chamber 2 includes an environmentally controlled delay line 11, in order to allow various reactions being performed on the moving surface a given length of time before being assayed. The controlled delay line 11 may include an enclosed pulley system 10, such that the moving surface 1 travels back and forth in the environmental chamber 2. Alternatively, the controlled delay line 11 may include a drum that rotates, such that the moving surface 1 travels around the drum in the environmental chamber. The advantage of a delay line 11 comprising a pulley system or drum is that the delay line becomes much more compact than if it were implemented in a linear, elongated conformation. In various embodiments of the invention, the system requires that the drop be held at least in part by surface tension while it hangs for at least some specified period of time at various angles, such as beneath the surface or on its side, during the time it spends on the pulley or drum. In an alternate embodiment, a pulley system is wound such that the belt traverses a path that is horizontal with the pulleys rotating around a vertical axis and the droplets are suspended on the top or bottom of the belt or laminate. In this case, the droplet will tend to slide due to momentum at each turn of the pulley system. Another embodiment includes moving the surface in a spiral configuration, such that the droplets never hang, again momentum becomes an issue. In each of these embodiments, the parameters of droplet size and the energy of the surface interaction between the droplet and the surface of the tape or laminated tape must be chosen such that the droplet is not lost due to gravity and/or momentum. The interaction energy is determined by the material chosen for the surface and the chemical components of the droplet. The droplets may be allowed to slide slightly while being suspended from the side, but not so much that sliding would cause mixing of two or more drops, unless such mixing was desired. If droplets slide slightly during their vertical motion on a drum or pulley system, they will tend to slide an equal amount in the opposite direction on the next half turn of the pulley or drum, thus putting them approximately back where they began prior to the first instance of sliding.

Due to the propensity of aqueous microdroplets to evaporate, resulting in changes in concentration of analytes and reagents, various measures may be implemented to limit evaporation. At the same time, temperature must be controlled for consistent and optimal chemical, biochemical or biological reactions.

One means of preventing evaporative loss is to keep those parts of laminate 6 that contain desired microdroplets in a humidified environment, since drops having fluid volumes several microliters or less evaporate rapidly when in a low humidity environment. The relative humidity necessary depends on the size of the microdroplets and the incubation time for the assay, but can be greater than 95%. Humid air may be actively pumped into a substantially sealed environment surrounding the moving surface. A water reservoir may also be placed inside of the sealed environment. Temperature may be controlled by heating either the air in the sealed environment, the moving surface 1 and/or laminate 6 itself, or the water vapor being pumped in. Heat may be applied by various means including resistive heating, infrared light, or microwave radiation.

In accordance with one embodiment of the invention, a method to maintain a high humidity environment during droplet transport takes advantage of a mechanical guide that laterally constrains the belt, as shown in FIG. 8. The belt 94 moves on a support block 95 fits in a groove whose depth is approximately three-quarters the belt thickness. An enclosure 93 consisting of a metal plate with a machined groove fits on top enclosing a volume through which a droplet 91 on the belt's 94 surface is moved. To prevent drop evaporation during transport, the enclosed volume needs to be kept at a constant and high humidity. The groove through which belt 94 moves is partially filled with water 92. As water 92 evaporates, the water vapor fills the enclosure volume to keep the relative humidity high and constant. Water 92 can be readily injected at one end and transported the length of the groove by the relative friction between belt 94 and water 92 and the mechanical action of the transverse grooves on the bottom side of belt 94.

In another embodiment of the invention, the rate of evaporation is reduced by coating the droplets with a substance to limit evaporation. For example, by adding dodecanol or a similar surfactant, a hydrophobic barrier is formed on the outside of the drop to prevent evaporation.

In alternative embodiments of the invention, certain reagents that are extremely hydrophilic may be added to the droplet to limit evaporation. These include polymers such as polyethylene glycol, gels such as agarose, and small molecules such as glucose.

The design of the laminate may incorporate features to limit evaporation. The laminate may contain recessed areas, divots or through-holes that reduce the exposed surface area of the droplets. If the laminate is designed so that the drops do not extend past the surface of the laminate, the laminate may be sealed, such as by lamination with a water impermeable material, or covered with a hydrophobic liquid such as octane, decane, dodecane, mineral oil or silicone oil. The hydrophobic liquid should be chosen such that it is sufficiently non-volatile at the working temperature and that desired molecules in the microdroplet do not partition into it. To further limit evaporation of the microdroplets as they are being placed on the laminate, the dispensing heads of the sample delivery devices such as syringe banks may penetrate narrow slots, holes or septa in a humidified track.

In various embodiments of the invention, it is advantageous to control the amount of time a reaction is allowed to proceed before the drop is assayed. This can be done in four ways. The first is by sampling at different locations in the incubation chamber. The close proximity and regular spacing of the tape loops in the incubation chamber permits scanning of the drops at different times by moving the detector from loop to loop or by using multiple detectors.

Secondly, a variable path length delay line may be used to vary the sample residence time in the chamber. This can be achieved by moving a bank of pulleys, or by the use of festoons or dancers.

A third method for varying reaction times is by stopping the reactions at various points in the incubation chamber. For example, a series of eight identical reactions could be placed on the moving surface/laminate in order. A stop solution (a solution that stops the reaction from proceeding) can be added to each drop at different locations in the chamber, resulting in different times of reaction. Then the drops can be assayed as the tape leaves the chamber, and kinetic rate constants can be obtained from the data.

The fourth method is to add a reaction “start” solution to the drops at different places in the chamber, such that the drops are reacting at different times and hence duration before they are analyzed.

Analysis

The samples need not be transferred to conventional types of chemical vials or multi-well plates for most types of analysis. Many types of chemical assays can be performed directly on the chemical reaction products as they are moved via the moving surface. Non-destructive spectroscopic methods such as fluorescence, phosphorescence, fluorescence polarization, Raman, nuclear magnetic resonance (NMR) and absorption spectroscopy can be performed on the samples as they are moved to appropriate positions for the assays to be performed. In various embodiments of the invention, the droplet is hung from the moving surface while being analyzed, the droplet adhering to the moving surface through, at least in part, surface tension. In a preferred embodiment, a spectrometric analysis technique, such as mass spectrometry, can be performed by removing aliquots of the sample at specific points via the moving surface. The ability to translocate the sample using the moving surface allows for multiple types of spectroscopic and/or spectrometric assays to be performed on each sample in a sequential manner. Multiple designs for delivering a sample from a moving surface to an analyzer, such as a mass spectrometer, are possible. These may include, but are not limited to, the following approaches.

Continuous Aspiration System

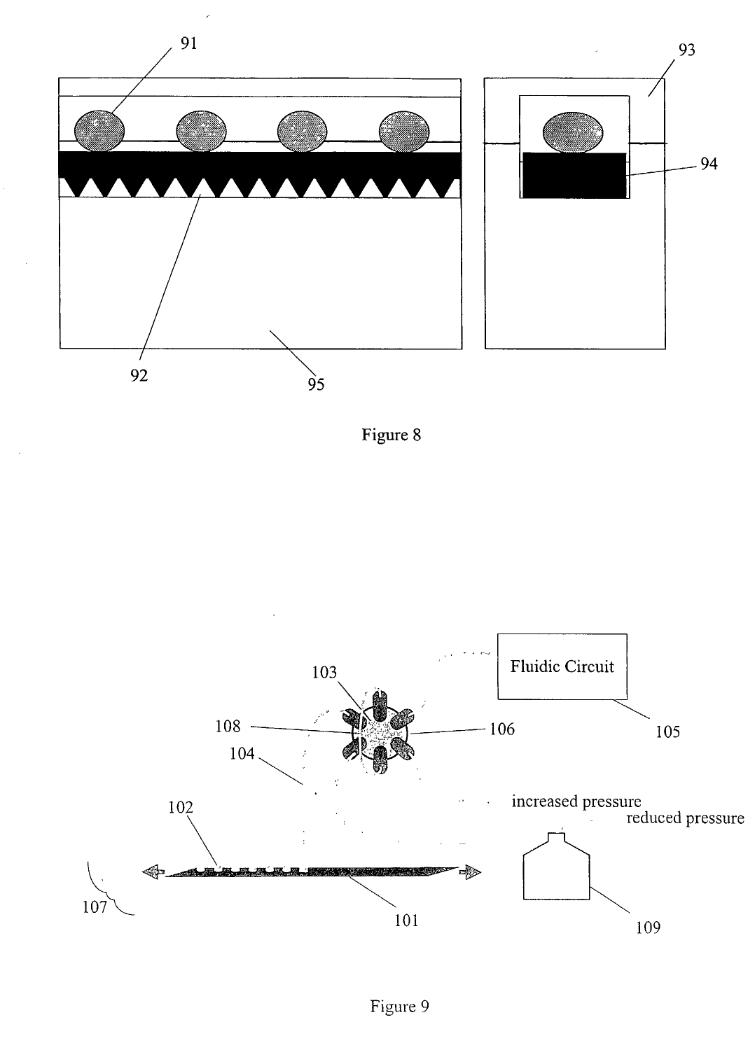

FIG. 9 is a schematic diagram of a valve assembly 107, in accordance with one embodiment of the invention. Instead of a syringe based system typically used in automated injection systems, a continuous aspiration system is used to alternatively aspirate samples and wash solution. By aspirating wash solution through the aspirator prior to receipt of the next sample, the time consuming step of cleaning a syringe by repetitively aspirating and dispensing wash solution is eliminated.

The assembly 107 includes an injection valve 106. A reduced pressure and an increased pressure is applied, by pumps for example, to a first port and a second port of injection valve 106, respectively.

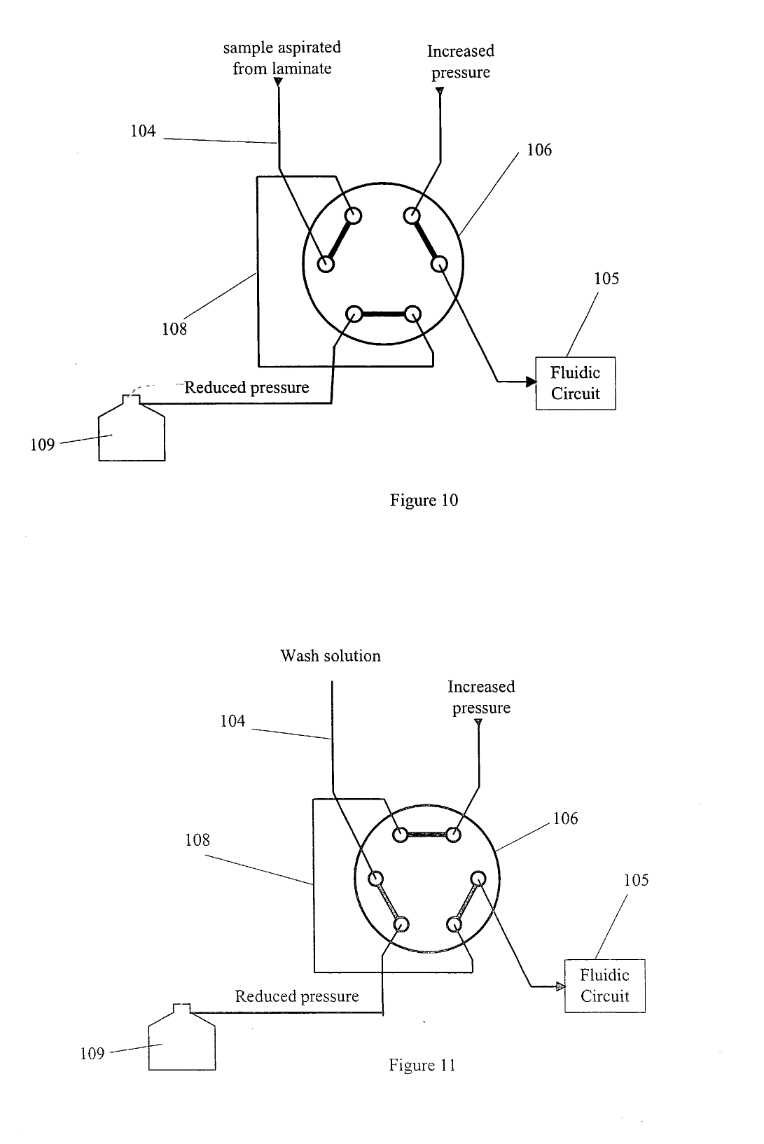

As shown in more detail in FIG. 10, when the injection valve 106 is not activated, the reduced pressure is used to aspirate a sample 102 from moving surface 101 through aspirator tube 104 and into a sample loop 108. Aspirator tube 104 may be, without limitation, narrow-bore capillary tubing. Enough of the sample to fill sample loop 108 with a defined volume is aspirated. Any excess sample aspirated is collected in a trap 109 that may be positioned, for example, between the injection valve 106 and the reduced pressure source.

Upon actuation of the injection valve 105, the metered amount of sample is introduced to a fluidic circuit 105 by applying increased pressure, as shown in FIG. 11. The amount of sample to be injected can thus be controlled by the size of the sample loop 108. The fluidic circuit 105 may include, for example, an analyzer such as a chromatography column or a mass spectrometer. The sample may be presented to the analyzer using a variety of standard systems, including atmospheric pressure chemical ionization (APCI) or electrospray ionization (ESI).

In various embodiments, a wash solvent or buffer solution is positioned between the region of increased pressure and the injection valve 106. While the injection valve 106 is activated and after the sample has been presented to the analyzer, the high pressure flushes the sample loop 108 and fluidic circuit 106 of the sample just analyzed. The sample loop 108 and fluidic circuit 105 is then ready to receive the next sample.

To clean the aspiration tube 104 prior to deactivation of valve 106 and aspiration of the next sample, the aspirator tube 104 is dipped into a wash solvent or buffer solution, and the reduced pressure is applied to aspirate wash solvent through the aspirator tube 104 and into trap 109. Thus, the combination of the constant negative pressure and the in-line trap eliminates the need for repetitive aspiration and dispensing of wash solution through a syringe.

The timing of the injection valve is critical, since the sample to be analyzed must be collected within the sample loop 108 of the injection valve 106. If the injection valve 106 is actuated too soon, the sample may not have completely filled the sample loop 108 and little or no sample may be actually injected. Alternatively, if the injection valve 106 is actuated too late, a large amount of sample may pass completely through the loop 108 and end up in the trap 109.

In various embodiments, the timing of the injection valve 106 can be determined by calculating the linear flow of the liquid sample through the aspiration tube and into the loop. This calculation may be based on, for example and as known in the art, the internal diameter of the tubing used, the pressure drop applied by the reduced pressure (typically a maximum of 1 atmosphere), the viscosity of the fluid being aspirated, and the temperature. In other embodiments, the timing of the injection valve 106 can be determined empirically.

Typical automated injection systems operate by placing the samples to be analyzed in predetermined locations, such as microtiter plates, and serially addressing those locations with a syringe based sample aspiration sample. Such an approach is possible using continued aspiration by moving the tip of the aspiration tube so as to address different samples arranged in an array. Preferably, the internal volume of the aspiration tube is kept to a minimum, since sample trapped within the aspirator at the time of injection valve activation will be lost. The speed that the aspiration tube can be moved is highly dependent on the motors and drive systems used. Achieving accurate high-speed movement typically requires fast motors and complex control systems.

Referring to FIGS. 9-11, in other embodiments of the invention the sample aspiration tube 104 is mounted in a fixed position relative to a fiduciary position, such as earth and/or an analyzer, and a series of sample and wash solvent is delivered to the aspiration tube 104 at the desired throughput rate. The samples may be delivered in a conventional format such as a microtiter plate where the microtiter plate is moved with respect to the aspiration tube 104. In preferred embodiments, the samples are position on moving surface 101 in a linear fashion with alternating volumes of sample and wash solution. When the first sample reaches the aspiration tube 104, the sample is aspirated into the injection valve 106 and fills the sample loop 108. The injection valve 106 is then actuated and the sample is delivered through fluidic circuit 105, which as described above, may include a mass spectrometer or a chromatography column. After analysis, the fluidic circuit 105 is flushed with a wash solution to remove residual sample. During the time that the fluidic sample is being flushed with the wash solution, the next volume of fluid is aspirated into the aspiration tube 104. This volume of fluid is now wash solution and because the injection valve 106 is still actuated it is not aspirated into the sample loop 108 but rather is directly delivered to the trap 109. After the aspiration tube 104 and fluidic system 105 is cleaned, the injection valve 106 is ready to accept the next sample for analysis and is deactivated. By fixing the position of the aspiration tube 104 and alternating samples and wash, motion may be controlled in only a single direction and a single injection valve can act as the interface to the fluidic circuit.

Note that when the injection valve is not activated, the high pressure may be applied so as to continue to flush the fluidic circuit 105 with either wash or buffer solution. Thus, the injection valve 106 is continuously delivering a flow of solution to the fluidic circuit. Plugs of samples from the sample loop 108 are introduced into this stream upon activation of the valve 106. Typically, minimal linear diffusion takes place between the plugs of sample and the wash as they move from the injection valve 106 to the fluidic circuit 105.

In mass spectrometry, it is important to differentiate the sample signals from wash. The data recorded on the mass spectrometer appears as a series of peaks corresponding to the individual samples interspaced with lower signal corresponding to the cleaner solvent that separates the samples.

However, in samples that have a low signal level, the difference between the mass spectrometry signals obtained from the sample and the mass spectrometry signals obtained from the wash may not be significantly different. Assigning and integrating peak areas can be a challenging task under ideal conditions, and is made even more difficult by the large number of peaks that must be integrated in a HTS.

Accordingly, a software algorithm may be implemented for accurate sample peak integration, in accordance with one embodiment of the invention. The algorithm relies on the principle that unless the injection valve 106 is activated, wash is delivered to the mass spectrometer. Upon actuation of the injection valve 106, the contents of the sample loop 108 are delivered to the mass spectrometer. The time delay between the actuation of the injection valve 106 and the sample appearing at the mass spectrometer is a function of the internal volume of the fluidic circuit 105 between the mass spectrometer and the injection valve 106, and the flow rate at which the fluidic pumps are being operated. This time delay between the injection valve 106 and the mass spectrometer can be empirically determined by injection of a high concentration of a standard solution known to produce a large mass spectrometer signal and by watching for the appearance of a response on the mass spectrometer after actuation of the injection valve 106. Once the time delay between the actuation of the injection valve 106 has been determined, the algorithm can be used to accurately integrate the peak area for each sample.

The injection valve 106 actuation may be triggered, in various embodiments, by a computer (not shown), and a log of the timing is maintained. The valve 106 actuation times is then synchronized with the mass spectrometer signal. The leading edge of each sample peak is identified by applying a constant time delay, calculated as described above, to each valve 106 actuation event. The trailing edge of each peak is identified by assigning a constant elution time to each sample. Since the leading and trailing edge of each peak is known, the peak area can be determined by integrating the mass spectrometer signal between the leading and trailing edges of each sample window. In cases where the sample is lost or removed from the moving surface/laminate and the injection valve 106 is not activated, the non-actuation is noted in the log, and no sample peak area integration occurs.

Additional sample preparation steps may be performed while the droplet is in the valve. Prior to delivery to the analyzer the sample can be presented to a matrix of one or more types of immobilized or insoluble resins, beads, polymers, or particles with or without surface coatings for the removal of salts or other contaminants. The removal of contaminants with such a system can occur by the selective adsorption of the undesirable contaminants with the analyte of interest not being adsorbed and presented to the mass spectrometer. In an alternative embodiment of the invention, the sample is selectively adsorbed to the matrix under one set of conditions but is desorbed from the matrix under another set of conditions. The cleanup procedure could take place before, within, or after the valve assembly.

Piezo-electric Dispensing Units

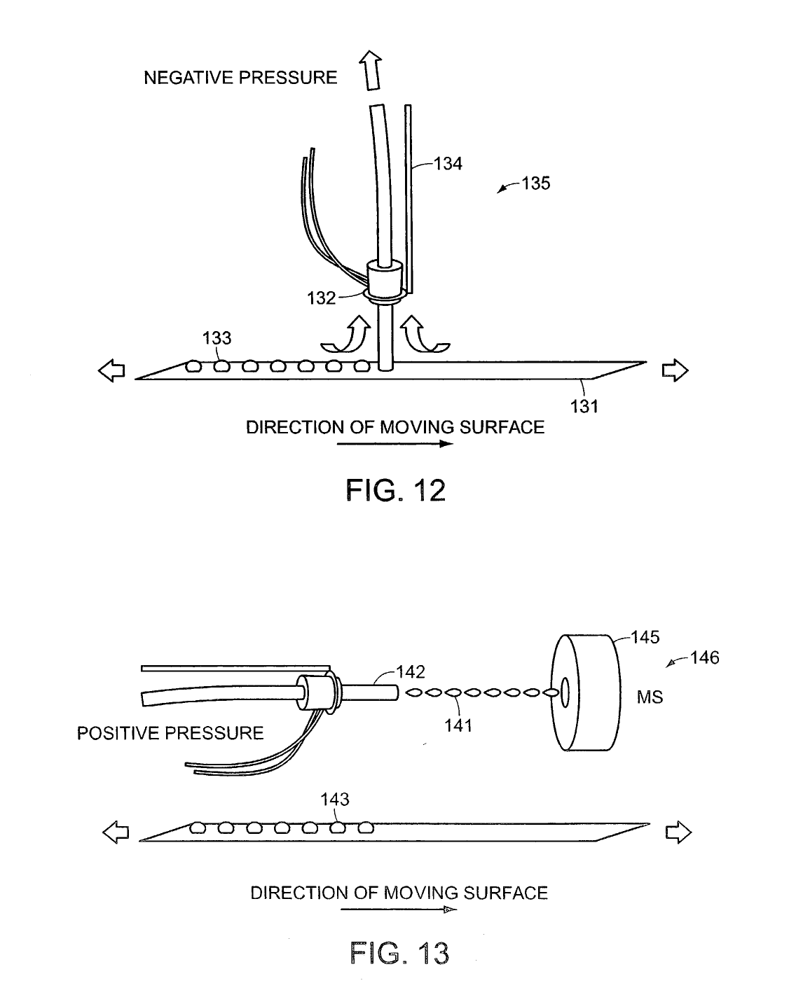

In accordance with another embodiment of the invention, FIG. 12 is a schematic diagram of a piezo-electric unit assembly 135 that removes the sample 133 to be interrogated from the moving surface 131 by aspiration. If desired, the sample 133 to be aspirated can be desalted or purified of contaminants prior to aspiration into a piezo-electric unit 132, which may be positioned by a position arm 134. Sample 133 to be interrogated is then dispensed from piezo-electric unit 132 and analyzed, for example, by a mass spectrometer. The piezo-electric system 146 could dispense the sample 143 in a stream of very small droplets 141, as shown in FIG. 13, similar to atomization that takes place in standard electrospray ionization mass spectrometry (ESI-MS). By adjusting the geometry of the stream of droplets 141, the mass spectrometer inlet 145 temperature, and the flow rate and geometry of the sheath gas enough solvent can be evaporated from the micro-droplets 141 for direct analysis of the resulting ions by mass spectrometry.

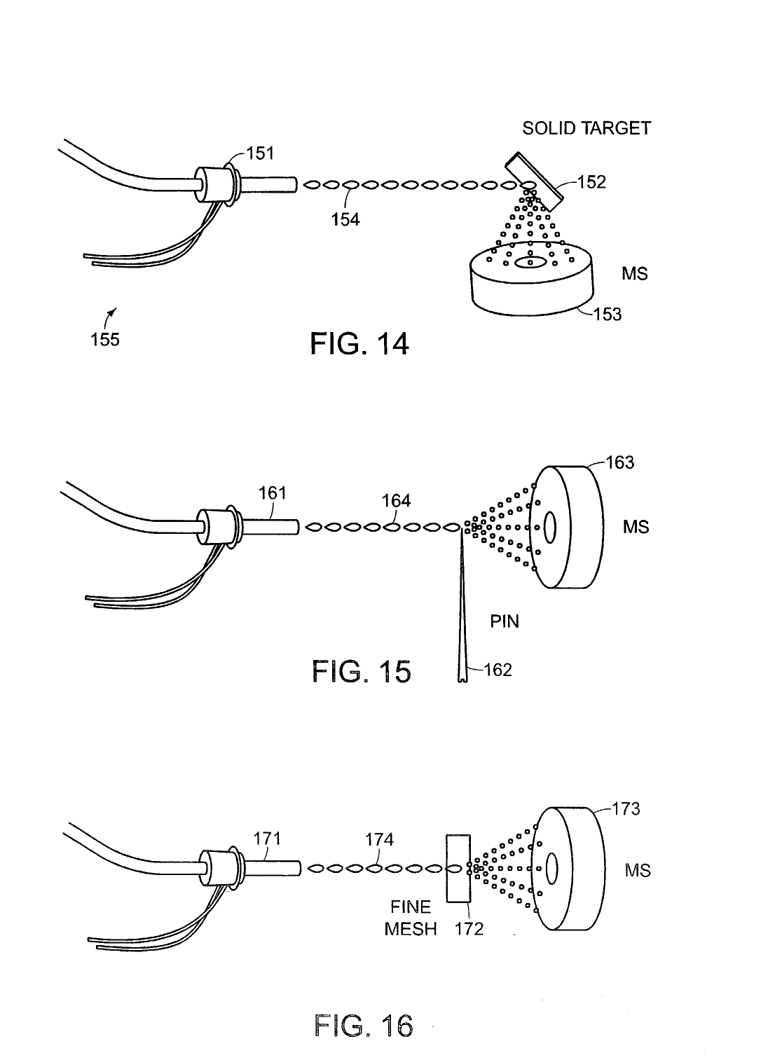

In other embodiments of the invention, a piezo-electric unit 151 can deliver the sample in the form of a stream of micro-droplets 154 to a surface 152 proximal to the inlet orifice 153 of the mass spectrometer, as shown in the piezo-electric system 155 depicted in FIG. 14. The resulting atomization that takes place because of the splashing of a droplet after a high-speed collision with a surface is similar to that in ESI-MS. The surface to which sample stream 154 is directed could be coated with a variety of hydrophobic or hydrophilic coatings, its position and geometry could be optimized and an electric charge can be applied to the surface and the surface can be heated to assist in the optimal sample ionization and atomization for delivery to the mass spectrometer. The geometry of sample stream 154, inlet 153 temperature, and the flow rate and geometry of the sheath gas can also be optimized. In another embodiment, a piezo-electric unit 161 can deliver a sample in the form of a stream of micro-droplets 164 at the point of a sharp pin or needle 162 that is in proximity to the inlet orifice 1653 of the mass spectrometer, as shown in FIG. 15. Alternatively, the piezo-electric unit 171 can deliver a sample in the form of a stream of micro-droplets 164 to a fine mesh in proximity to the inlet orifice 1653 of the mass spectrometer, as shown in FIG. 16. The micro-droplets will further atomize upon hitting this surface and further disperse into an atomizing spray, similar to that in most atmospheric pressure ionization schemes currently used. The geometry and shape of the needle or pin with respect to the mass spectrometer inlet orifice or the sample stream can be optimized to provide the largest amount of atomization. The surface of the pin or needle can be coated with a hydrophobic or hydrophilic surface and a voltage can be applied to the pin to optimize the atomization process. Additionally, a gas such as methane or ammonia can be introduced to the atomization chamber to perform a chemical ionization.

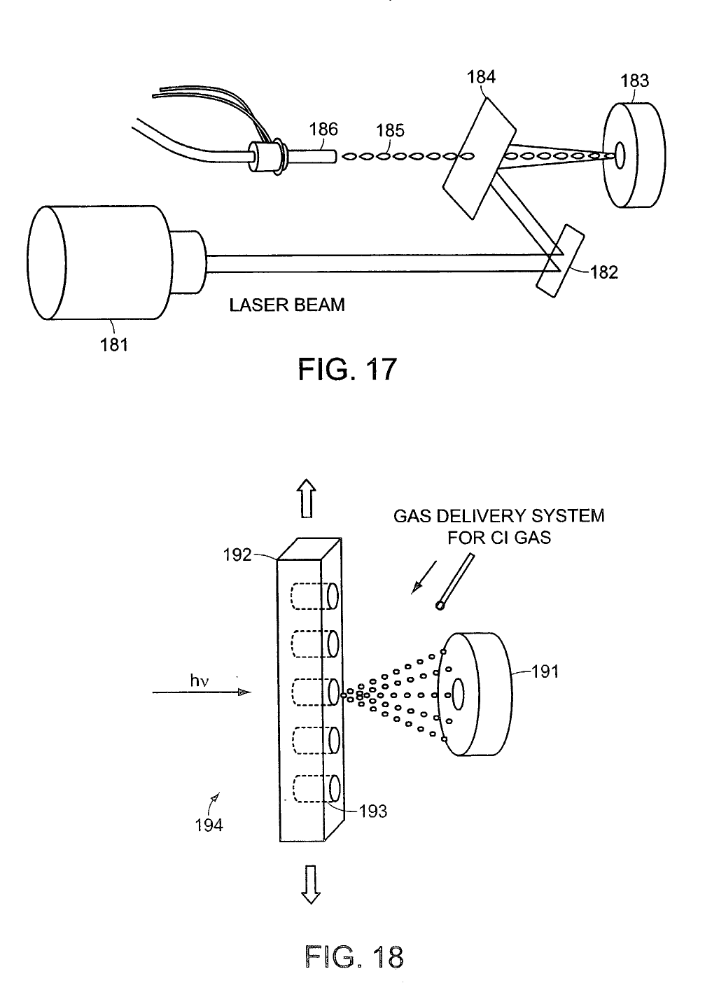

In further embodiments of the invention, the droplet stream 185 from the piezoelectric unit 186 can be directed through a hole in the center of a parabolic mirror 184 towards the inlet orifice 183 of the mass spectrometer, as shown in FIG. 17. A laser beam from a laser 181 is directed at and reflected from the mirror 182 so that the light beam is collinear with the droplet beam. Laser 181 wavelength is chosen for optimal absorption by the solvent to cause evaporation, and a long interaction length between drop stream 185 and the laser beam allows the use of a low power laser 181. Optimization of the laser power, wavelength and characteristics of piezo-electric droplet dispensing can allow for a complete evaporation of solvent from the droplets 185. Sample ionization may be achieved by applying an electrical potential to the gold plated parabolic mirror 184 through which the droplets 185 are fired. Alternatively, an atmospheric pressure chemical ionization scheme can be used to ionize samples.

Rapid Heating

FIG. 18 is a schematic diagram of a system 194 for rapidly heating samples on a moving surface 192 so as to cause atomization, in accordance with one embodiment of the invention. A sample is atomized and directed at the inlet orifice 191 of an analyzer by rapidly heating a small amount of the sample in an enclosed volume 193 with a narrow channel from which it can be released. The sample reservoir 193 may either be incorporated directly into the belt itself, or the samples could be transferred from the belt into reservoirs on a separate instrument. The geometry and structure of the exit channel from the sample reservoir 193 can be designed such that upon rapid heating of the reservoir the natural expansion of the sample cause it to be ejected from the reservoir through the orifice in the form of an atomized spray. This spray is analogous to ESI-MS and can be directed at the inlet orifice of the mass spectrometer. The geometry and shape of the reservoir 193 and exit channel with respect to the mass spectrometer inlet orifice 191, the mass spectrometer inlet temperature, and the flow rate and character of the sheath gas can be optimized to provide the largest amount of atomization. Sample ionization can be accomplished by chemical ionization by increasing the partial pressure of a gas such as methane or ammonia near the atomized sample and by introducing the gas and sample to a corona discharge needle. This approach is similar to that used in atmospheric pressure chemical ionization (APCI-MS) schemes.

The heating of the reservoir can be accomplished either thermoelectrically or by focusing a laser beam inside the sample within the reservoir.

Pneumatic or Explosive Force

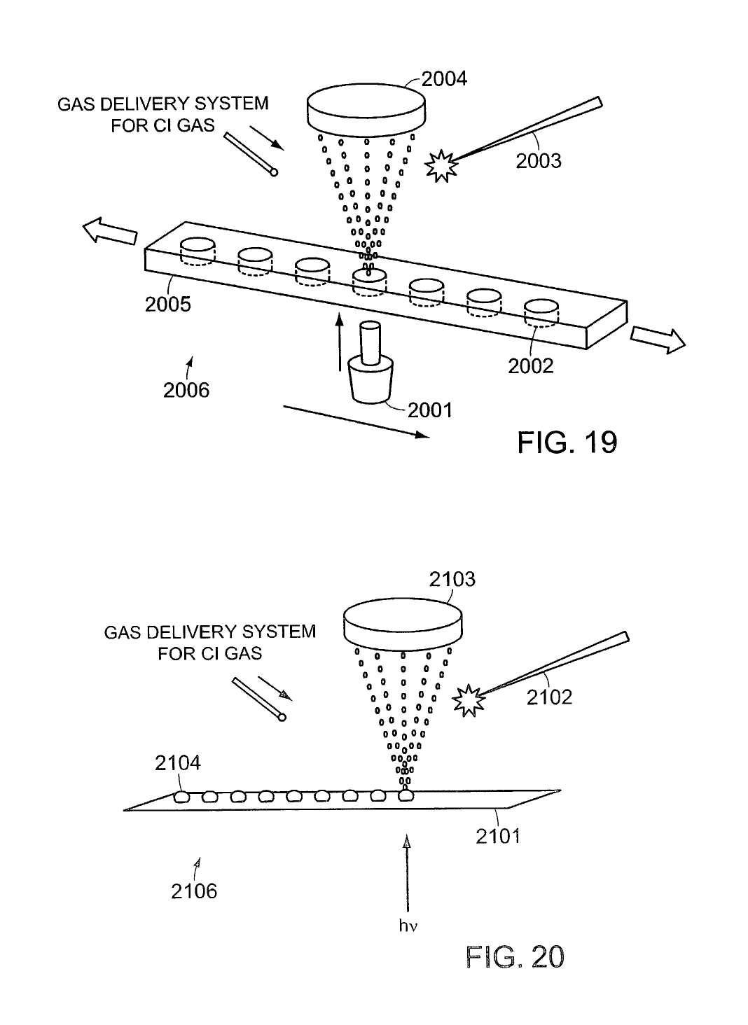

FIG. 19 is a schematic diagram of a system 2006 for forcibly ejecting a sample from a moving surface 2005, in accordance with one embodiment of the invention. A sample is placed within a reservoir 2002 with the appropriate geometry such that if forcefully ejected from reservoir 2002 the sample will atomize into a fine spray. If desired, the sample can be ejected from the reservoir through a narrow channel to increase the amount of sample that is atomized. Reservoirs 2002 may either be built directly into moving surface 2005 or samples can be transferred from moving surface 2005 to a separate instrument containing reservoirs 2002. Reservoir 2002 is positioned with a geometry such that when the sample is ejected from reservoir 2002 it is atomized and directed at the analyzer, for example, at the inlet orifice 2004 of the mass spectrometer. Reservoir 2002 may be shaped such that the atomization process is optimized. The sample may either be ejected with the use of a small explosive charge or by a pneumatic piston 2001 that actuates and applies pressure on the bottom of reservoir 2002. The geometry and shape of reservoir 2002 and exit channel with respect to the mass spectrometer inlet orifice, mass spectrometer inlet 2004 temperature, and the flow rate and character of the sheath gas may be optimized to provide the desired amount of sample atomization and mass spectrometry signal. Ionization of the sample may be performed by the use of an ionization gas such as methane or ammonia and a corona discharge needle 2003 similar to APCI-MS.

Vibration

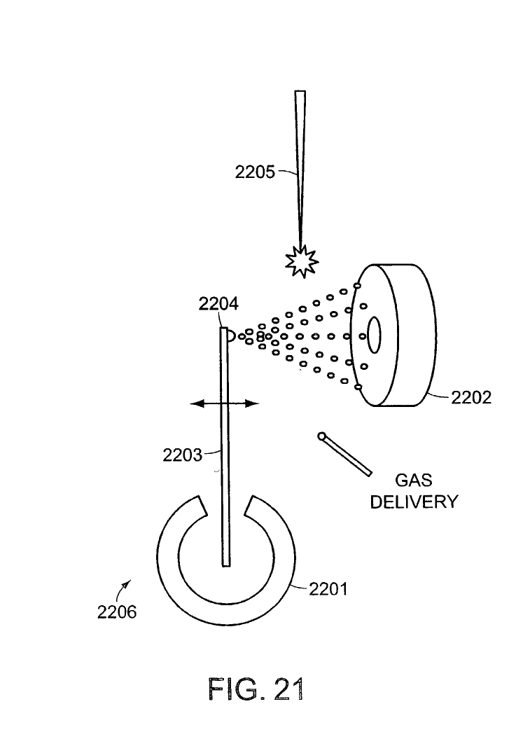

FIG. 20 is a schematic diagram of a system 2106 for rapidly vibrating samples on a moving surface 2101 so as to cause atomization, in accordance with one embodiment of the invention. A liquid sample 2104 deposited on a thin surface 2101 is atomized by rapid vibration of that surface 2101. The surface 2101 onto which the sample is deposited may be a thin film, such as the moving surface itself, or alternatively, the sample can be transferred to a suitable surface such as a thin film with a surface coating, a narrow flexible strip, or the point of a pin or needle. The rapid vibration of the sample 2104 may be performed by focusing a pulsed laser onto the surface near the sample 2104, or onto the backside of the surface onto which the sample has been deposited. Alternatively, acoustic systems using ultrasonic waves or a rapid mechanical system can be used to generate vibration. The sample may also be made to vibrate by using an alternating current 2201 to cause a probe 2203 onto which the sample 2204 has been deposited to move rapidly back and forth, as shown in FIG. 21. In this embodiment, the vibrating device 2206 is similar to the probe of an atomic force microscope (AFM), where the sample is deposited onto the tip of a probe similar to that of an AFM and rapid vibration of the probe results in atomization of that sample. In accordance with various embodiments of the invention, the surface onto which the sample is deposited can be made hydrophilic or hydrophobic, and the temperature of the surface and mass spectrometer inlet 2103, 2202 and the geometry and flow rate of the sheath gas can be optimized to provide the best sample atomization. Additionally, a voltage may be applied to the surface onto which the sample is deposited to assist in the formation of an appropriate spray for mass spectrometer interfacing. If desired, ionization of the sample can be performed by the use of a chemical ionization gas such as methane or ammonia and a corona discharge needle 2102, 2205 similar to APCI-MS.

Use of Stop Droplets

Slow traditional biochemical screening systems require a stop solution to control the amount of time a reaction is allowed to proceed, even when an environmental chamber, delay line, and/or incubation chamber is not utilized. Selection of a stop solution may be difficult in that harsh reagents are often needed to inactivate enzymes or cells and the reagents may degrade the analyte of interest or interfere with the analysis, resulting in the need to remove the interfering chemicals through additional purification. In accordance with various embodiments of the present invention, each droplet may be dispensed onto substantially continuously moving surface, combined with a reagent, and then analyzed at a sufficient enough speed so as to prevent the resulting reaction from proceeding for too long prior to analysis. Accordingly, it is not necessary to add a stop solution to the droplets analyzed.

For example, when inputting droplets into a mass spectrometer using only volatile buffers, throughput rates can be achieved that are limited only by the throughput rate of the automated injector, as described in above embodiments of the invention. The time saved by not performing a desalting and/or purification step, which is typically required in traditional mass spectrometer screening systems and which delays the serial input of each droplet into the mass spectrometer, in combination with the speed of transporting the droplets via the moving surface, eliminates the need to add a stop solution.

In the case where a desalting or other purification step is used, the purification will stop the reaction. In conventional LC-MS techniques, the seperation times may be on the order of minutes, necessitating a stop solution to prevent most of the reactions of interest from proceeding to completion prior to analysis and thus destroying to useful information in a kinetic assay.

High Throughput Screening Software Architecture

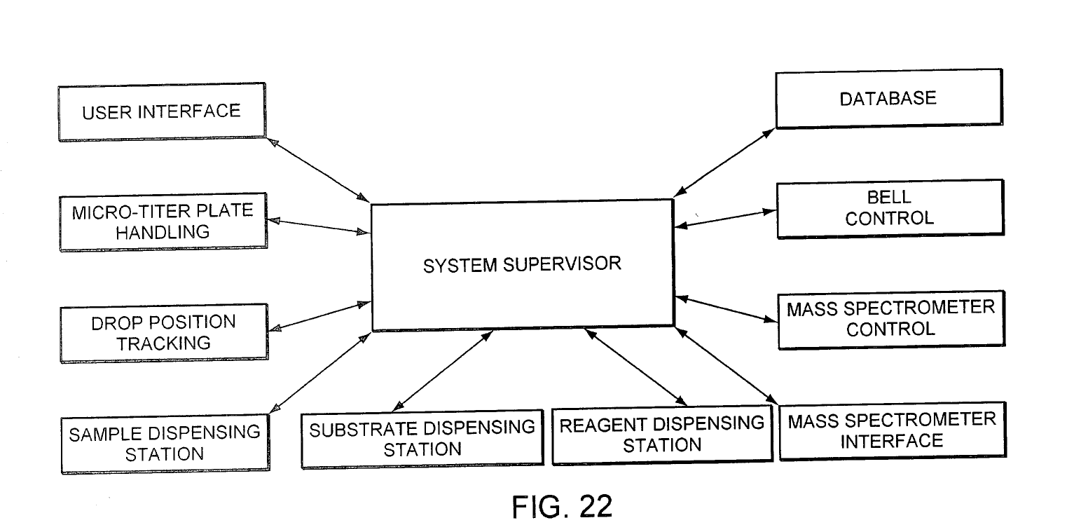

In accordance with one embodiment of the invention, the high throughput screeningsystem architecture may be conceptually divided into two basic functional layers organized as a hierarchical relationship between subordinate task orientated components and a supervisory component which manages the coordination of the subordinate tasks, as shown in FIG. 22. In FIG. 22, relationships between the system architecture elements are shown with lines indicating the flow of data between elements. Each component represents an independently running thread of execution or an entirely separate process, which may run on separate processors where desired. This is an important characteristic that is emphasized in order to highlight the flexibility and reliability of the system. For example, the system allows the selective application of real-time processing computing platforms where they are required without burdening other system elements that do not have real-time requirements with the added complexity and costs associated with real-time processing.

The architecture maximizes the functional capabilities and flexibility of the high throughput system by allowing swift and smooth integration of new or reconfigured electro-mechanical configurations to the system while at the same time ensuring that overall, the system is not globally effected by the changes in sub-system designs. Additionally, the architecture enhances system reliability by condensing the various system aspects into independent islands of functionality that may monitor and report their own progress to the supervisory layer. The supervisory layer can then coordinate the overall system operation based on the state of the lower layers without being burdened with unnecessary information. Each layer may be conceptually reduced to a finite state machine with well-defined states and transitions thus achieving the robust and deterministic behavior required. This segregation also improves system reliability by ensuring that errors occurring in low level sub-systems do not corrupt the entire throughput process. The supervisory layer can observe such failures and various corrective actions initiated or in the most extreme cases, operation may be gracefully shutdown while appropriate status reports are generated for the human operators.

System components may include a conveyer belt, sample, substrate and reagent dispensing stations, a microtiter plate handling system, an analyzer interface, an analyzer control system, a database of sample information, a droplet tracking system, a supervisor system, and a user interface. Examples of each of these components follow.

The conveyor belt may include a narrow and long regularly cogged timing belt, a system of pulleys and tensioning elements, a stepper motor for actuation, and a rotary encoder for feedback. The belt is commanded to maintain a constant velocity during system operation. The encoder is attached to an idler pulley and provides motion state feedback of the belt. Using this encoder the velocity of the belt can be accurately recorded, belt failures or stalls detected, and individual drop positions within the system may be tracked. The rotary encoder tracking belt motion serves as the primary source of synchronization for the various subsystems making up the throughput screeningsystem. Since there is a fixed distance measured along the length of the belt between any two actively controlled system elements that perform an operation on a given drop, the belt encoder provides the most accurate and dependable method for triggering such operations and in preferred embodiments of the invention serves as the primary method of system synchronization.

A sample library dispensing station may include a multi-axis positioning system actuated by micro-stepper motors outfitted with high-resolution linear encoders to ensure accurate positioning of each axis. The dispensing station moves an array of micro-syringes to the microtiter plate holding the sample to be analyzed, withdraws a volume of sample using an array of micro-syringes and finally dispenses the drops onto the surface of the moving belt. The sample dispensing station is required to keep pace with the desired drop throughput rate by retrieving samples from particular wells of the microtiter plate sample and placing them onto the conveyor belt.

The substrate and reagent dispensing stations may include a micro-valve(s) for dispensing those fluids and a drop sensing system. These stations wait for a sample drop to arrive, which may be directly sensed using an optical, capacitive or magnetic-based sensor whereupon the valve is actuated adding substrate or reactant to the sample drop. The presence of particular drops placed by the sample dispensing station are thus verified and missing drops are reported. In one embodiment of the invention, a substrate-dispensing valve is placed at the beginning of the belt, which will dispense drops at regularly spaced intervals as triggered by the belt encoder. This ensures that the drops will be accurately spaced on the belt, which is crucial to proper system operation.

The microtiter plate handling system may include a plate retrieval and stacking robotic system which presents plates of samples to be screened to the dispensing station and removes the plates when no longer needed. Such a system may be software controlled. Additionally, if the plates are equipped with bar codes a bar code scanner may be integrated into the plate handler and used to automate plate identification.

The analyzer interface system may include a drop sensor and a multi-port fluidic valve that introduces samples to the analyzer. The drop sensor detects the presence of the drop ahead of the input tubing to the multi-port valve. After the drop has been moved by the belt under the tubing orifice, the valve is actuated by a signal from the computer and the drop is drawn into the tube by negative pressure. A second signal from the computer actuates the valve to inject the sampled drop into the input of the analyzer.

The analyzer control system may include a routine that manages all communications between the throughput system and the analyzer as well as the configuration of the analyzer at run time. This task involves configuring the analyzer appropriately given the sample drops being fed into it and controlling how data is generated and recorded by the device. Configuration changes may include changing the sensitivity of the device, or creating a series of data files recording the results of the scans for example.

A database of sample information may be created for each screening process in which screening data pertaining to uniquely identified drops is recorded for analysis. Examples of information likely to be recorded include chemical information about the compounds in the library, substrate and reactants added, and analyzer results.

In various embodiments of the invention, the supervisory task receives high-level commands from the operator interface and manages the automated screening process. The supervisory task may control the execution of the other system tasks, such as the belt task, or the dispensing control tasks, by being responsible for the starting and stopping of these tasks, and querying them for information about their current state. Each sub task may have a finite number of possible execution states, which may be regulated by the supervisor task. A simple table may be maintained by the supervisor task that describes the entire state of the high throughput screening, which may be updated by querying the various sub tasks at some regular interval. Each sub-task managed by the supervisor maintains a data structure accessible in some way by the supervisor task, which will serve as the source of the information for the supervisor task's global state table. The contents of the global state table maintained by the supervisor task in turn dictate what controlling actions should be initiated by it. After querying each sub task for an update on their respective state data, the supervisor task examines the new information and initiates a reflexive response action if so dictated by the new information. For example, after querying the sub tasks the belt task's state indicates that the belt has become stuck for some reason. This condition would be discovered by the belt encoder failing to increment, a condition which would be noted by the belt task and the belt task state updated appropriately. This fatal error condition would initiate a preprogrammed response by the supervisor task, which would then effect a controlled but immediate shut down of the screening process and an alarm message generated for the user interface.

Accurate identification and droplet tracking of a particular sample droplet as it passes through the system can be advantageously incorporated into the high throughput screeningsystem. The droplet tracking system may include a run time database that maintains a data-structure updated at a regular and constant rate which tracks the position of all drops as they pass through the system. Based on this tracking, information about particular drops can be forwarded to, and may act as a trigger for, other system elements that perform some operation on particular drops when they arrive at particular positions along the belt. For example, the drop tracker may be responsible for triggering the reagent dispensing task to expect a certain drop and to perform its sensing/verification of the drop as well as adding the reagent to that drop.

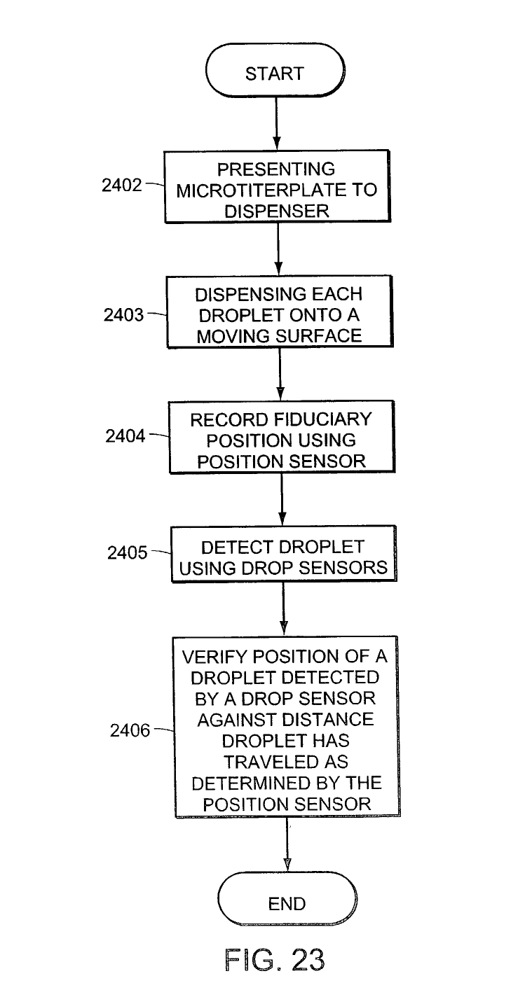

FIG. 23 is a flowchart showing an example of how a droplet can be tracked, in accordance with one embodiment of the invention. At system start up, the operator provides data on the microtiter plates containing the samples to be analyzed during the screening, step 2401. In various embodiments, each plate has a unique id and the wells on each plate have a unique address. For example, the number 3445-7-8 would uniquely identify a drop from the well at the 7th row, 8th column of plate 3445. The microtiter plate may be fitted with a bar code sticker and a bar code reader could be integrated into the throughput system to automate the process of identifying individual plates.

The microtiter plate handling subsystem is then commanded to retrieve and present to the sample dispensing station a particular plate 2402. Once this is accomplished, the dispensing station is commanded to retrieve and place on the belt a particular row of samples from the plate, step 2403, and the exact position of the drop on the belt is recorded, as reported by a position sensor, which may be a rotary encoder, step 2404. In this manner, a fiduciary position for each droplet on the belt is obtained, which may be saved to random-access memory. Particular droplets are then tracked using drop sensors as they pass through the system, step 2405. The drop sensors are located at known positions relative to the position sensor. Positions of particular droplets detected by the drop sensor(s) can thus be verified against the requisite distance traveled by each droplet as determined by the position sensor, step 2406. If the sensor fails to register an expected droplet the failure is recorded by the supervisory layer and the droplet is appropriately marked in the data tracking system. Drop sensors may be located at substrate and reactant stations, for example. Additionally, this sensing and recording process may be repeated at the analyzer interface as well. A similar drop-sensing device may also verify the existence of a particular and uniquely identified drop as it is fed to the analyzer. Taken together, the belt position sensor (rotary encoder), and the three drop sensors provide a redundant drop tracking and verification system. Data retrieved from the analyzer may then be correlated with the drop tracking data recorded by the throughput subsystem by recording the belt position of each drops introduction into the analyzer via the analyzer interface.

Additionally, reactants with known analyzer properties may be inserted at known locations in each microtiter plate to aid in tracking and de-bugging of errors that may occur during the assay process. For example, in screening for inhibitors, some wells in the microtiter plates will either contain no inhibitors (e.g buffer only) or a known inhibitor of the enzyme(s) under study. Measurement of these known cases will serve to detect errors in the fluidic handling or drop tracking sub-system.

In accordance with one embodiment of the invention, the user interface may be a graphical interface presented to an operator on a standard desktop that is running a windows based operating system. Alternatively, the user interface may be a command line based system. The interface may allow configuration of a screening process which, in some cases, may last up to 10 hours or more. In order to accomplish this the interface must allow a user/operator to enter into the system various types of data, including, but not limited to: how many microtiter plates to retrieve and process; which rows of samples to retrieve from the plate and input to the screening system; names for the data file(s) that are to be generated; and configuration settings for the analyzer, which may include specifying a per sample or per plate granularity.

In an alternative embodiment, the disclosed method may be implemented as a computer program product for use with a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A system for high throughput screening of fluid samples, the system comprising:
a sample aspiration tube;
an injection valve, the injection valve being capable of alternatively applying a reduced pressure to a first fluid source and to a second fluid source, in each case via the sample aspiration tube, the first fluid source for filling a sample loop with samples, and the second fluid source for flushing the aspiration tube.

2. The system according to claim 1, further comprising an inline trap in fluid communication with the injection valve for capturing excess fluid aspirated from the first fluid source and all fluid aspirated from the second fluid source.

3. The system according to claim 2, wherein the inline trap is coupled between a region of reduced pressure and the injection valve.

4. The system according to claim 1, further comprising a fluidic circuit in fluid communication with the injection valve, the fluidic circuit for receiving a sample from the sample loop via the injection valve.

5. The system according to claim 4, wherein the fluidic circuit includes an analyzer for determining a characteristic of the sample.

6. The system according to claim 5, wherein the analyzer includes a chromatography column.

7. The system according to claim 5, wherein the analzyer includes a mass spectrometer.

8. The system according to claim 1, further comprising a moving surface for moving a plurality of droplets with respect to the sample aspiration tube, each droplet including one of the first fluid and the second fluid, each droplet to be aspirated by the sample aspiration tube.

9. The system according to claim 8, wherein the sample aspiration tube is fixed in position relative to earth.

10. The system according to claim 8, wherein the moving surface is a timing belt characterized by teeth for engagement by a sprocket.

11. The system according to claim 8, wherein the moving surface is reinforced with a material characterized by a strength greater than that of the moving surface.

12. The system according to claim 11, wherein the material is chosen from the group of materials consisting of glass, aramid, and steel.

13. The system according to claim 8, further comprising a laminate attached to the moving surface, wherein the droplets are deposited onto the tape.

14. A system for high throughput screening of fluid samples, the system comprising:
a sample aspiration tube;
an injection valve;
a sample loop in fluid communication with the injection valve;
a fluidic circuit in fluid communication with the injection valve, the fluidic circuit for receiving samples via the injection valve, from the sample loop; and
an inline trap coupled between a region of reduced pressure and the injection valve, wherein the injection valve applies a substantially continuous reduced pressure to the sample aspiration tube.

15. The system according to claim 14, wherein the injection valve is capable of alternatively applying the reduced pressure to a first fluid source and a second fluid source, in each case via the sample aspiration tube, the first fluid source for filling the sample loop with a sample, and the second fluid source for flushing the sample aspiration tube.

16. The system according to claim 14, wherein the fluidic circuit includes an analyzer.

17. The system according to claim 16, wherein the analyzer is one of a mass spectrometer and a chromatography column.

18. A system for high throughput screening of fluid samples, the system comprising:
a sample aspiration tube;
an injection valve having a sample loop, the injection valve having a first position and a second position;
an inline trap coupled between a reduced pressure source and the injection valve, wherein when the valve is in the first position the sample aspiration tube is coupled to the negative pressure source so as to aspirate a first fluid into the sample loop, the inline-trap capturing excess fluid aspirated, and wherein when the valve is in a second position the sample aspiration tube is coupled to the negative pressure source so as to aspirate a second fluid, the inline-trap capturing the second fluid.

19. The system according to claim 18, wherein the second fluid is a wash solution.

20. The system according to claim 18, further comprising a fluidic circuit, wherein when the valve is in the second position the sample loop is coupled to an increased pressure so as to divert the first fluid in the sample loop to the fluidic circuit.

21. The system according to claim 20, wherein the fluidic circuit includes one of a mass spectrometer and a chromatography column.

22. A system for high throughput screening of a plurality of droplets, the system comprising:
a moving surface;
a tape adhered to the moving surface;
a dispenser for dispensing each droplet onto a surface of the tape; and
a means for performing on at least one droplet one or more operations from the group of operations consisting of mixing, diluting, concentrating, heating, cooling, humidifying, filtering, and analyzing.

23. The system according to claim 22, wherein the tape includes a pressure sensitive adhesive for adhering the tape to the moving surface.

24. The system according to claim 23, wherein the pressure sensitive adhesive does not outgas at temperatures between 0° C. and 95° C.

25. The system according to claim 23, wherein the pressure sensitive adhesive is an acrylic adhesive.

26. The system according to claim 22, wherein the surface of the tape has a surface energy lower than 31 dynes/cm.

27. The system according to claim 22, wherein the surface of the tape has a surface energy greater than 44 dynes/cm.

28. The system according to claim 22, wherein the surface of the tape includes one of Teflon, polyethylene, and polyester.

29. The system according to claim 22, further comprising at least one pulley across which the moving surface travels, wherein the tape stretches to avoid breaking when the moving surface travels across the pulley, and the tape contracts after the moving surface leaves the pulley so as to remain adhered to the belt.

30. The system according to claim 22, wherein the moving surface travels in a path having a curvature, wherein the tape stretches to avoid breaking when the moving surface travels across the curvature, and the tape contracts after the moving surface passes the curvature so as to remain adhered to the belt.

31. The system according to claim 30, wherein the curvature has a radius between 0.5 cm and 5 cm.

32. The system according to claim 22, wherein the moving surface is a timing belt characterized by teeth for engagement by a sprocket.

33. The system according to claim 22, wherein the moving surface is chosen from the group of materials consisting of rubber, polyurethane, and laminate composite.

34. The system according to claim 22, wherein the moving surface is reinforced with a material characterized by a strength greater than that of the moving surface.

35. The system according to claim 34, wherein the material is chosen from the group of materials consisting of glass, aramid, and steel.

36. The system according to claim 22, further including one of an antistatic gun and ionizer for removing static charge build up on the tape.

37. The system according to claim 22, wherein the tape is permanently adhered to the moving surface.

38. The system according to claim 22, wherein the tape is removably adhered to the moving surface.

39. A system for high throughput screening of a plurality of droplets, the system comprising:
a moving surface;
a dispenser for dispensing each droplet onto the moving surface;
a syringe needle for dispensing a reagent into at least one of the droplets, the syringe needle coated with a hydrophobic coating; and
a means for performing on at least one droplet one or more operations from the group of operations consisting of mixing, diluting, concentrating, heating, cooling, humidifying, filtering, and analyzing.

40. The system according to claim 39, where the hydrophobic coating is chosen from the group of coatings consisting of Teflon, Parylene, or FluoroPel.

41. The system according to claim 39, further including a controller for controlling the syringe needle such that the syringe needle penetrates the droplet prior to dispensing the reagent.

42. The system according to claim 41, wherein the controller controls the syringe needle such that the syringe needle penetrates a leading edge of the droplet while the droplet is moving via the moving surface.

43. The system according to claim 42, wherein the moving surface travels in a defined path and the reagent is dispensed at a fixed location on the path.

44. The system according to claim 43, wherein the controller controls the syringe such that the syringe is removed from droplet after dispensing the reagent and before the trailing edge of the droplet passes the fixed location.

45. A system for high throughput screening of a plurality of droplets, the system comprising:
a moving surface for transporting the plurality of droplets;
at least one dispenser for dispensing fluid onto the moving surface;
a controller for calibrating the at least one dispenser; and
a means for performing on each droplet one or more operations from the group of operations consisting of mixing, diluting, concentrating, heating, cooling, humidifying, filtering, and analyzing.

46. The system according to claim 45, wherein the at least one dispenser is a solenoid valve that applies a pressure pulse to dispense fluid.

47. The system according to claim 45, wherein the at least one dispenser dispenses the plurality of droplets onto the moving surface.

48. The system according to clam 45, wherein the at least one dispenser dispenses a reagent into one or more of the plurality of droplets.

49. The system according to claim 45, wherein the controller includes a feedback loop, the feedback loop including at least one sensor for detecting a size of one or more droplets on the moving surface.

50. The system according to claim 48, wherein the at least one sensor is an optical sensor.

51. The system according to claim 45, wherein the controller adjusts at least one parameter of the at least one dispenser from the group of parameters consisting of pressure pulse length, number of pressure pulses, and aperture size.

52. A method for mass spectrometry sample peak integration in a high throughput screening system, the high throughput screening system including an injection valve that when activated injects a fluid sample into a substantially continuous flow of wash solution being delivered, via a fluidic circuit, to an input of a mass spectrometer, the method comprising:
recording an actuation time of the injection valve;
calculating a sample peak leading edge by adding a predetermined time delay to the actuation time;
calculating a sample peak trailing edge by adding a predetermined duration time to the sample peak leading edge; and
integrating an output signal from the mass spectrometer between the sample peak leading edge and sample peak trailing edge.

53. The method according to claim 52, further comprising determining the predetermined time delay by, at least in part:
injecting, via activation of the injection valve, a solution into a substantially continuous flow of wash solution being delivered to the fluidic circuit, the wash solution associated with a wash solution spectrometer signal and the solution associated with a solution mass spectrometer signal that is recognizable from the wash solution spectrometer signal; and
observing how long it takes after actuation of the injection valve before the solution mass spectrometer signal is received at an output of the mass spectrometer.

54. The method according to claim 53, further comprising determining the predetermined duration time by observing how long the solution mass spectrometer signal is observed at the output of the mass spectrometer.

55. A method for high throughput screening of fluid samples, the method comprising:
applying, via an injection valve, a reduced pressure to a sample aspiration tube;
alternatively aspirating, via the sample aspiration tube, a first fluid and a second fluid, the first fluid for filling a sample loop with samples, the second fluid for flushing the sample aspiration tube;
capturing excess fluid aspirated from the first fluid source and all fluid aspirated from the second fluid source in an inline trap.

56. The method according to claim 55, wherein applying the reduced pressure to the sample aspiration tube includes applying the reduced pressure substantially continuously to the sample aspiration tube.

57. The method according to claim 55, further comprising:
applying an increased pressure, via the injection valve, to the sample loop so as to pump each sample to a fluidic circuit.

58. The method according to claim 57, the method further comprising:
analyzing a characteristic of each sample received by the fluidic circuit.

59. The method according to claim 58, wherein analyzing includes performing at least one of mass spectrometry and chromatography.

60. The method according to claim 57, wherein a wash solution is coupled between a region of increased pressure and the injection valve, the method further comprising:
pumping a stream of wash solution, via the injection valve, to a fluidic circuit;
injecting, upon activation of the injection valve, the sample loop into the stream of wash solution, such that the wash solution flushes the sample loop and the fluidic circuit alternatively receives one of the sample and the wash solution.

61. The method according to claim 60, the method further comprising:
analyzing a characteristic of the sample received by the fluidic circuit.

62. The method according to claim 61, wherein analyzing includes performing at least one of mass spectrometry and chromatography.

63. The method according to claim 55, further comprising moving a plurality of droplets with respect to the sample aspiration tube, each droplet alternately including one of the first fluid and the second fluid, each droplet to be aspirated by the sample aspiration tube.

64. A method for high throughput screening of a plurality of droplets, the method comprising:
adhering a laminate onto a moving surface;
dispensing each droplet onto the laminate;
performing on at least one droplet one or more operations from the group of operations consisting of mixing, diluting, concentration, heating, cooling, humidifying, filtering, and analyzing.

65. A method according to claim 64, further comprising removing the laminate from the moving surface.

66. The method according to claim 64, further comprising removing static charge from the laminate prior to dispensing the droplets.

67. A method for high throughput screening of a plurality of droplets, the method comprising:
dispensing each droplet onto a moving surface
dispensing a reagent into at least one of the droplets using a syringe needle coated with a hydrophobic coating; and
performing on at least one droplet one or more operations from the group of operations consisting of mixing, diluting, concentration, heating, cooling, humidifying, filtering, and analyzing.

68. The method according to claim 67, wherein dispensing the reagent includes:
pushing the syringe needle into the droplet;
dispensing the reagent into the droplet; and
removing the syringe.

69. The method according to claim 68, wherein the moving surface travels along a path and wherein dispensing the reagent includes dispensing the reagent at a fixed location along the path.

70. The method according to claim 69, wherein dispensing the reagent includes:
pushing the syringe needle into a leading edge of the droplet while the droplet is moving via the moving surface;
dispensing the reagent into the droplet; and
removing the syringe needle from the droplet prior to the droplet moving past the syringe needle.

71. A method for high throughput screening of a plurality of droplets, the method comprising:
dispensing each droplet onto a moving surface;
measuring a characteristic of at least one droplet on the moving surface;
calibrating at least one dispenser based, at least in part, on the characteristic; and
performing on at least one droplet one or more operations from the group of operations consisting of mixing, diluting, concentration, heating, cooling, humidifying, filtering, and analyzing.

72. The method according to claim 71, wherein calibrating includes adjusting at least one parameter of the dispenser from the group of parameters consisting of pressure pulse length, number of pressure pulses, and aperture size.

73. The method according to claim 71, wherein measuring a characteristic of the droplet includes performing optical imaging.

74. The method according to claim 71, further comprising calculating a running average of the characteristic measured, and wherein calibrating includes comparing the running average to a predetermined value.

75. The method according to claim 71, wherein measuring includes measuring a characteristic of numerous droplets until one of a variance of the characteristic, a standard deviation of the characteristic, and a standard error of the characteristic drops below a predetermined value.

76. The method according to claim 71, wherein measuring a characteristic of at least one droplet includes measuring a size of at least one droplet.

77. A method for high throughput screening of a plurality of droplets, the method comprising:
dispensing each droplet onto a moving surface;
adding a volatile buffer to the at least one droplet; and
analyzing at least one characteristic of each droplet using a mass spectrometer, wherein the only buffer added to the droplet consists of a volatile composition.

78. The method according to claim 77, wherein no desalting is performed on the droplet prior to analyzing.

79. The method according to claim 77, wherein the volatile buffer includes at least one of ammonium formate, ammonium acetate, ammonium carbonate, and ammonium bicarbonate.

80. The method according to claim 77, wherein analyzing includes inputting each droplet into the mass spectrometer at a rate faster than one droplet every two seconds.

81. The method according to claim 77, wherein analyzing includes inputting each droplet into the mass spectrometer at a rate of substantially one droplet per second.

82. The method according to claim 77, further comprising adjusted the pH of each droplet by adding to each droplet at least one of formic acid, acetic acic, propionic acid, ammonium hydroxide, and triethylamine.

83. A method for high throughput screening of a plurality of biochemical samples, the method comprising:
adding a volatile buffer to each sample; and
inputting each sample into a mass spectrometer, wherein the only buffer added to the sample consists of a volatile composition.

84. The method according to claim 83, wherein no desalting is performed on the sample prior to inputting the assay into the mass spectrometer.

85. The method according to claim 83, wherein inputting each sample into the mass spectrometer includes inputting each sample into the mass spectrometer at a rate faster than one sample every two seconds.

86. The method according to claim 83, wherein inputting each sample into the mass spectrometer includes inputting each sample into the mass spectrometer at a rate of substantially one sample per second.

87. The method according to claim 83, wherein the volatile buffer includes at least one of ammonium formate, ammonium acetate, ammonium carbonate, and ammonium bicarbonate.

88. The method according to claim 83, further comprising adjusted the pH of the sample by adding to the droplet at least one of formic acid, acetic acic, propionic acid, ammonium hydroxide, and triethylamine.

89. A method for high throughput screening of a plurality of droplets, the method comprising:
dispensing each droplet onto a moving surface;
dispensing a reagent into each droplet;
performing on each droplet one or more operations from the group of operations consisting of mixing, diluting, concentration, heating, cooling, humidifying, filtering, and analyzing, wherein no stop solution is added to the plurality of droplets.

90. The method according to claim 89, wherein performing on each droplet one or more operations includes performing mass spectrometry.
